(19) United States
(12) Patent Application Publication
(10) Pub. No.: US 2026/0357884 A1
(43) Pub. Date: Nov. 12, 2026

(54) DRIVE MOUNT TENSIONING SYSTEM AND METHOD

(71) Applicant: Master Power Transmission, Inc., Greenville, SC (US)

(72) Inventors: Michael Kelly, Greenville, SC (US); Anthony M. Cinquemani, Greenville, SC (US)

(21) Appl. No.: 19/665,574

(22) Filed: May 1, 2026

Related U.S. Application Data
(60) Provisional application No. 63/802,820, filed on May 9, 2025.
(60) Provisional application No. 63/980,653, filed on Feb. 11, 2026.

(51) Int. Cl. F16H 57/035; F16H 7/14; F16H 57/022; H02K 5/26; H02K 7/10; F16H 57/02

(52) U.S. Cl. CPC F16H 57/035; F16H 7/14; F16H 57/022; H02K 5/26; H02K 7/1004; F16H 2057/02034

(57) ABSTRACT

A drive mount system is provided for extending around a rotating belt drive extending between a driving device and a driven device. The drive mount system includes a mount housing having a back plate upon which the driving device and the driven device are configured to mount such that portion of a drive shaft of the driving device and the driven shaft of the driven device are enclosed in an interior cavity of the mount housing. The drive mount system also includes a tensioning system configured to selectively secure the driving device relative to the back plate and to permit the driving device to be selectively positioned along a machine direction of the back plate to effect desired tensioning of the belt drive.

### REFERENCE TO RELATED APPLICATIONS

The present Patent Application claims benefit of U.S. Provisional Patent Application No. 63/802,820, filed May 9, 2025, and claims benefit of U.S. Provisional Patent Application No. 63/980,653, filed Feb. 11, 2026.

### INCORPORATION BY REFERENCE

U.S. Provisional Patent Application No. 63/802,820, filed May 9, 2025, and U.S. Provisional Patent Application No. 63/980,653, filed February 11, 2026, are specifically incorporated by reference herein as if set forth in their entireties.

### TECHNICAL FIELD

The present disclosure relates generally to the field of mounts, guards or casings for power transmission systems such as belt drives in communication with motors and gear reducer systems that are operatively coupled to one another for selective input or output of torque. More particularly, the invention relates to a technique facilitating assembly and disassembly of drive mount systems for belt driven power transmission systems.

### BACKGROUND

As one will appreciate, a wide range of applications exist for rotary drive systems, throughout all aspects of industry, material handling, agriculture, and transportation, to mention just a few fields. In general, many such systems are based upon the generation of rotary motion that is transmitted to various machine elements through couplings, gear drives, transmissions, and the like. In systems where a prime mover, such as an electric motor, rotates at a speed other than that desired at the actual application, gear reducers or variable speed drives are typically employed to reduce or increase the speed and torque to the desired range.

In such rotary drive systems, it is common to utilize a driving device, such as an electric motor, to drive a driven device, such as, for example and without limitation, the exemplified gearbox. In these cases, a power transmission system, such as an exemplified belt drive, can extend between the driving device and the driven device. Rotating equipment guarding standards, such as OSHA/MSHA requirements, require that in certain commercial and industrial settings a guard be placed around at least any exposed rotational aspects of the driving and driven devices as well as the power transmission system as a means of guarding or preventing a person's body or clothing from coming between such rotating devices and the power transmission system and becoming entangled in the equipment.

Conventionally, safety compliant guards have traditionally been accomplished by building one or more housings that are configured to adequately cover respective “drive” portions of the driving device, the driven device and the power transmission system. Such guards tend to be bulky, heavy and require extensive time and effort to remove when maintenance is necessary on the underlying guarded equipment. End customers often have to add additional guard features for regulatory and safety compliance requirements. Such conventional safety compliant guards add to the complexity and cost of designing, installing and maintaining such industrial equipment.

There is a need, therefore, for an improved drive mount system enclosing the respective “drive” portions of the driving device, the driven device and the power transmission system. There is, at present, a particular need for a simple and straightforward drive mount system which can be retrofitted into existing systems or installed in new systems to facilitate both assembly and disassembly of the drive mount system to compliantly enclose an area around the respective “drive” portions of the driving device, the driven device and the power transmission system, which drive mount system is easy to install and which can be easily adjusted and secured around the power transmission system so as to selectively enclose the open areas around and about the power transmission system.

### SUMMARY

To improve the state of the art, disclosed herein is a drive mount system for use with a power transmission system, and methods of use thereof, utilizing novel features and functionalities.

A drive mount system is provided that is configured to extend around a rotating belt drive extending between a driving device and a driven device. The drive mount system has a mount housing with a removable front cover and an opposing back plate. In operation, the driving device is configured to mount to the back plate such that a portion of the drive shaft of the driving device can be enclosed therein an interior cavity of the mount housing and the driven device is configured to mount to the back plate such that a portion of driven shaft of the driven device can be enclosed therein the interior cavity of the mount housing. The driving device being configured to be selectively secured relative to the back plate along a machine direction of the back plate to allow the desired positioning of the drive shaft relative to the position of the driven shaft.

A first pulley is coupled to the drive shaft of the driving device and a second pulley is coupled to the driven shaft of the driven device with a belt drive being in contact with the respective first and second pulleys to effect transfer of rotational energy from the first pulley to the second pulley. There is also provided means to selectively position the driving device relative to and along a machine direction of the back plate to effect desired tensioning of the belt drive.

Still other aspects, embodiments, and advantages of these exemplary aspects and embodiments, are discussed in detail below. Moreover, it is to be understood that both the foregoing information and the following detailed description are merely illustrative examples of various aspects and embodiments and are intended to provide an overview or framework for understanding the nature and character of the claimed aspects and embodiments. Accordingly, these and other objects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain the principles of the embodiments discussed herein. No attempt is made to show structural details of this disclosure in more detail than can be necessary for a fundamental understanding of the exemplary embodiments discussed herein and the various ways in which they can be practiced. According to common practice, the various features of the drawings discussed below are not necessarily drawn to scale. Dimensions of various features and elements in the drawings can be expanded or reduced to more clearly illustrate the embodiments of the disclosure.

FIGS. 1A and 1B schematically illustrate a first embodiment of a drive mount system configured to extend around a rotating belt drive extending between a driving device and a driven device and showing a mount housing having removable front cover (shown in both an open and closed position) and an opposing back plate upon which the driving device is configured to be positioned relative to such that a distal portion of a drive shaft of the driving device is positioned therein an interior cavity of the casing and upon which the driven device is configured to mount such that a distal portion of a driven shaft of the driven device is positioned therein the interior cavity of the mount housing. The driving device being configured to be selectively secured relative to the back plate along a machine direction of the back plate to effect desired tensioning of the belt drive. In this embodiment, the machine direction is substantially vertical.

FIGS. 2A and 2B schematically illustrate the drive mount system of FIGS. 1A and 1B in an embodiment in which the machine direction of the back plate is substantially vertical.

FIGS. 3A and 3B schematically illustrate the first embodiment of the drive mount system configured to extend around a rotating belt drive extending between a driving device and a driven device and showing a mount housing having a removable front cover and an opposing back plate upon which the driving device is configured to be positioned relative to such that a distal portion of a drive shaft of the driving device is positioned therein an interior cavity of the mount housing and upon which the driven device is configured to mount such that a distal portion of a driven shaft of the driven device is positioned therein the interior cavity of the mount housing. The driving device being configured to be selectively secured relative to the back plate along a machine direction of the back plate to effect desired tensioning of the belt drive. In this exemplary embodiment, the machine direction is substantially horizontal.

FIG. 4 schematically illustrates the drive mount system of FIGS. 3A and 3B in an embodiment in which the machine direction of the back plate is substantially horizontal, showing the front cover of the mount housing positioned in an open position.

FIGS. 5 and 6 schematically an angled mount shim which is configured to be positioned between the back plate and the mating face of the driver device to ensure that the driver shaft is positioned at a desired degree of offset for receipt of an operative first pulley, thereby ensuring that the first pulley and a second pulley coupled to the driven shaft are positioned in a common plane, into which the belt drive will operate.

FIG. 7 is a side perspective view of a first embodiment of the interior surface of the back plate of the mount housing.

FIG. 8 is a side perspective view of the first embodiment of the exterior surface of the back plate of the mount housing.

FIG. 9 is a partial cross-sectional view showing an exemplary first mount plate positioned to overly an interior surface of the back member in opposition to the positioning of the machine interface of an exemplified c-faced electric motor such that conventional fasteners can securely space the relative position of the machine interface of the c-faced electric motor relative to the bottom surface of a first mount plate when fasteners are secured through the formed mount wells and into engagement with the threaded recesses in the machine interface of the c-faced electric motor. Also shown are sleeve spacers that allow for the passage of the fasteners to affect the desired spaced relationship of the respective first mount plate to portions of the underling back member while also allowing for selective positioning of the driving shaft of the driving device relative to the machine direction of the back plate.

FIG. 10 is a side perspective view of a first mount plate showing a plurality of openings that are positioned in an array that is shaped to mirror an array of threaded recesses in a machine interface of a driving device and showing a drive opening shaped to allow for the receipt of the drive shaft of the driving device. As shown, the array formed by the plurality of openings can include a first plurality of openings that are spaced from a second plurality of openings at a distance that is substantially the same as the distance that separates the respective pair of opposed elongated mount slots. Also shown is a mount ledge member that extends outwardly from the inner surface of the first mount plate and that defines a planar member having an elongated threaded aperture that is sized and shaped for complementary receipt of an elongated threaded bolt.

FIG. 11 is a side perspective view of a second mount plate that can be positioned in spaced opposition to the first mount plate of FIG. 10 and portions of the mounting surfaces of the formed mount wells. The second mount plate 90 showing a plurality of openings that are positioned in an array that is shaped to mirror the array of the plurality of openings of the first mount plate and showing a drive opening shaped to allow for the receipt of the drive shaft of the driving device.

FIG. 12 schematically illustrates a second embodiment of a drive mount system configured to extend around a rotating belt drive extending between a driving device and a driven device and showing a mount housing having a removable front cover (in a closed position).

FIG. 13 schematically illustrates the second embodiment of a drive mount system configured to extend around a rotating belt drive extending between a driving device and a driven device and showing a mount housing having removable front cover (in an open position) and an opposing back plate upon which the driving device is configured to be positioned relative to such that a distal portion of a drive shaft of the driving device is positioned therein an interior cavity of the casing and upon which the driven device is configured to mount such that a distal portion of a driven shaft of the driven device is positioned therein the interior cavity of the mount housing. The driving device being configured to be selectively secured relative to the back plate along a machine direction of the back plate to effect desired tensioning of the belt drive. In this embodiment, the machine direction is substantially vertical.

FIG. 14 is a side elevational view of the drive mount system of FIG. 12 configured to extend around a rotating belt drive extending between a driving device and a driven device and showing a mount housing having a removable front cover (in a closed position).

FIG. 15 is a partial, opposing side elevational view of the drive mount system of FIG. 14 configured to extend around a rotating belt drive extending between a driving device and a driven device and showing a mount housing having a removable front cover (in a closed position), further showing a portion of a formed ring structure of respective mounts and ribs that can act as guard structures to provide for compliance with applicable OSHA/MSHA rotating equipment guarding standards that require a guard to be placed around at least any exposed rotational aspects of the driving and driven devices as a means of guarding or preventing a person's body or clothing from coming into contact with such rotating.

FIG. 16 is a partial, perspective view of the drive mount system of FIG. 12 showing the driving device configured to mount to respective mount members of a mount assembly.

FIG. 17 is a side perspective view of the interior surface of a second embodiment of the back plate of the mount housing.

FIG. 18 is a side perspective view of the exterior surface of the second embodiment of the back plate of the mount housing.

FIG. 19 is a top elevational view of the exterior surface of the back plate of FIG. 18.

FIG. 20 schematically illustrates a mount assembly configured to be positioned relative to the back plate and to mount to the machine interface of a driving device. The mount assembly configured for selective positioning of the driving shaft of the driving device along the machine direction of the back plate and relative to a driven shaft of the driven device.

FIG. 21 is a side elevational view of FIG. 20 showing a mount assembly configured to be positioned relative to the back plate and the machine interface of a driving device. The mount assembly being configured for selective positioning of the driving shaft of the driving device along the machine direction of the back plate and relative to a driven shaft of the driven device.

FIGS. 22A – 22D schematically illustrate a mount member of the mount assembly.

FIG. 23 is a cross-sectional view showing a machine interface of a driving device being operatively connected to mount surfaces of a mounting member of a mount assembly by fasteners.

FIG. 24 schematically illustrates a cross-sectional view showing a mount assembly configured to be positioned relative to the back plate and configured to mount with the machine interface of a driving device. The mount assembly being configured for selective positioning of the driving shaft of the driving device along the machine direction of the back plate and relative to a driven shaft of the driven device.

FIG. 25 schematically illustrates a cross-sectional view showing a driven device being mounted to the back plate of the drive mount system.

FIG. 26 schematically illustrates a bottom view showing driven device being mounted to the back plate of the drive mount system and showing fasteners extending from the interior surface of the back plate for removable mounting of a front cover.

FIG. 27 schematically illustrates a guard member having a central opening, an upper slot, and a lower slot. The guard member having a general planar shape and has a mount surface surrounding the central opening that is sized and shaped to allow for positioning relative to a complementary face surface of a conventional c-faced electric motor.

FIG. 28 is a side perspective view showing the guard member of FIG. 27 positioned thereon the complementary face surface of a conventional c-faced electric motor and in contact with portions of the respective mount surfaces of a mounting member of a mount assembly such that the formed mount wells in the back plate are enclosed when the mount assembly is selectively positioned with respect to the machine direction of the back plate. As exemplarily shown, the c-faced electric motor is mounted to the respective mount surfaces of the mounting member of the mount assembly and is positioned in a desired positioned relative to the formed mounting wells.

FIG. 29 is an elevational view of the guard member of FIG. 28 positioned thereon the complementary face surface of a conventional c-faced electric motor and in contact with portions of the respective mount surfaces of a mounting member of a mount assembly such that the formed mount wells in the back plate are enclosed when the mount assembly is selectively positioned with respect to the machine direction of the back plate. Also shown is an exemplary a conventional torque bar or arm operatively coupled to the bar mount that is positioned toward the peripheral edge of the second lobe of the back member.

FIG. 30 schematically illustrates a perspective view showing a L-shaped scoop support that is coupled to the mount members of the mount assembly such that a distal portion of a drive shaft of the driving device is positioned therein the interior cavity of the mount housing. The L-shaped scoop support can be configured to operatively support a conventional foot mounted electric motor that has a plurality of footings. As shown, the L-shaped scoop support has a bottom surface that defines a plurality of openings that are configured to receive fasteners that are shaped and sized to feed through respective bores defined in each of the footings. Further shown, the scoop support has a mount surface that is integrally connected to a distal edge of the bottom surface.

FIG. 31 schematically illustrates a cross-sectional side view showing a foot mounted motor being mounted to a L-shaped scoop support that is coupled to the mount members of the mount assembly such that that a distal portion of a driven shaft of the driven device can be positioned therein the interior cavity of the mount housing.

FIG. 32 schematically illustrates a optional embodiment of a drive mount system configured to extend around a rotating belt drive extending between a driving device and a driven device and showing a mount housing having removable front cover (shown in a closed position) and an opposing back plate upon which the driving device is configured to be positioned relative to such that a distal portion of a drive shaft of the driving device is positioned therein an interior cavity of the casing.

FIG. 33 schematically illustrates an optional embodiment of the removable front cover of FIG. 32.

### DETAILED DESCRIPTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a pulley” can include two or more such pulleys unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It should be appreciated, that as used herein, terms of approximation, such as a “about” or “approximately,” refers to being within 10% margin of error.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “can,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular embodiment.

The phraseology and terminology used herein is for the purpose of description and should not be regarded as limiting. As used herein, the term "plurality" refers to two or more items or components. The terms "comprising," "including," "carrying," "having," "containing," and "involving," whether in the written description or the claims and the like, are open-ended terms, i.e., to mean "including but not limited to." Thus, the use of such terms is meant to encompass the items listed thereafter, and equivalents thereof, as well as additional items. Only the transitional phrases "consisting of" and "consisting essentially of," are closed or semi-closed transitional phrases, respectively, with respect to any claims. Use of ordinal terms such as "first," "second," "third," and the like in the claims to modify a claim element does not by itself connote any priority, precedence, or order of one claim element over another or the temporal order in which acts of a method are performed but are used merely as labels to distinguish one claim element having a certain name from another element having a same name (but for use of the ordinal term) to distinguish claim elements.

Disclosed are components that can be used to perform the disclosed methods and systems. These and other components are disclosed herein, and it is understood that when combinations, subsets, interactions, groups, etc. of these components are disclosed that while specific reference to each various individual and collective combinations and permutation of these cannot be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems can be understood more readily by reference to the following detailed description of preferred embodiments and the examples included therein and to the Figures and their previous and following description.

The invention provides a novel system and methodology for assembling and disassembling a drive mount system 10 for enclosing an area around the respective “drive” portions of a driving device 1, a driven device 5 and a power transmission system 9. Referring to the figures, embodiments of a drive mount system 10 configured to extend around a rotating belt drive extending between a driving device and a driven device are schematically illustrated. In the embodiments, the drive mount system 10 includes a mount housing 20 formed from a back plate 30 and a selectively removable front cover 25. The mount housing 20 defines an interior cavity 22 that is substantially enclosed when the front cover 25 is selectively placed in a closed position relative to the back plate 30 (from an open and/or removed position).

In embodiments, the driving device 1 of the drive mount system 10 includes an electric motor of various constructions that is configured to provide output rotation. Conventionally, the output of the electric motor is provided by a drive shaft 2 extending distally from a substantially flat end of the electric motor. As described and as one skilled in the art will appreciate, the drive mount system 10 of the present invention provides for the use of conventional NEMA electric motors (such as, and without limitation, c-face electric motors, belt-driven, foot mounted electric motors, and the like) of desired sizes.

In one exemplary embodiment, and as illustrated, it is contemplated that the driving device 1 can be a conventional NEMA "c-face” electric motor that has a conventional machine interface 3 surrounding the drive shaft 2 extending therefrom. The conventional machine interface typically includes a face plate having an array of threaded recesses 4 that are sized and shaped for receipt of a conventional threaded fastener. In a further aspect, it is contemplated the longitudinal axis of each threaded recess 4 extends parallel to the longitudinal axis of the drive shaft 2.

As illustrated, and without limitation, the conventional NEMA electric motors can be c-faced NEMA electric motors of various sizes. This embodiment, in which c-faced NEMA electric motors are used, allows for end user flexibility in the use of the drive mount system as they can selectively use the drive mount system with an appropriate sized c-faced electric motor for particular end user applications. Thus, in this exemplary embodiment, an end user would only need to stock conventional c-faced electric motors, of desired size, which motors can be mounted as described herein to the back plate of the mount housing.

As described in more detail in the embodiments described below, the machine interface 3 of the c-face electric motor can be configured to be coupled directly to a portion of an exterior surface of the back plate 30. Optionally, the machine interface 3 of the c-face electric motor can be configured can be operatively coupled to a mounting plate adaptor that can be coupled to a portion of the interior surface of the back plate. In a further option, it is contemplated that the machine interface 3 of the c-face electric motor can be configured to be operatively coupled to a motor mount assembly, which can be configured to be selectively positioned and secured to back plate at a desired position relative to the machine direction of the back plate.

In other embodiments, the driven device 5 of the drive mount system 10 can include a conventional gear reducer of various construction that is known in the art for converting output speeds and torques of driving devices to desired speeds and torques for an intended application, such as driving conveyors, rotating machinery and the like. Generally, such conventional gear reducers include one or more intermeshing gear sets arranged on a series of shafts between an input and an output. The input shaft of the gear reducer, e.g., the driven shaft 6, is designed to be operatively coupled to a driving device 1 such as the electric motor described above, while the output shaft of the gear reducer, typically a keyed shaft or sleeve, in configured to be conventionally coupled to the machine application to be driven. In aspects, the driven shaft 6 of the driven device 5, such as the exemplified gear reducer, extends distally from an input port defined in the exterior surface of the gear reducer.

Conventionally, the gear reducer typically includes an array of recesses that are sized and shaped for receipt of a conventional threaded fastener. In this aspect, the array of recesses are generally positioned about the periphery of a machine interface 8 that surrounds the driven shaft 6 extending therefrom. In a further aspect, it is contemplated the longitudinal axis of each recess extends parallel to the longitudinal axis of the driven shaft 6. Conventionally, a complementary nut can be used to secure the respective threaded fasteners relative to the formed recesses.

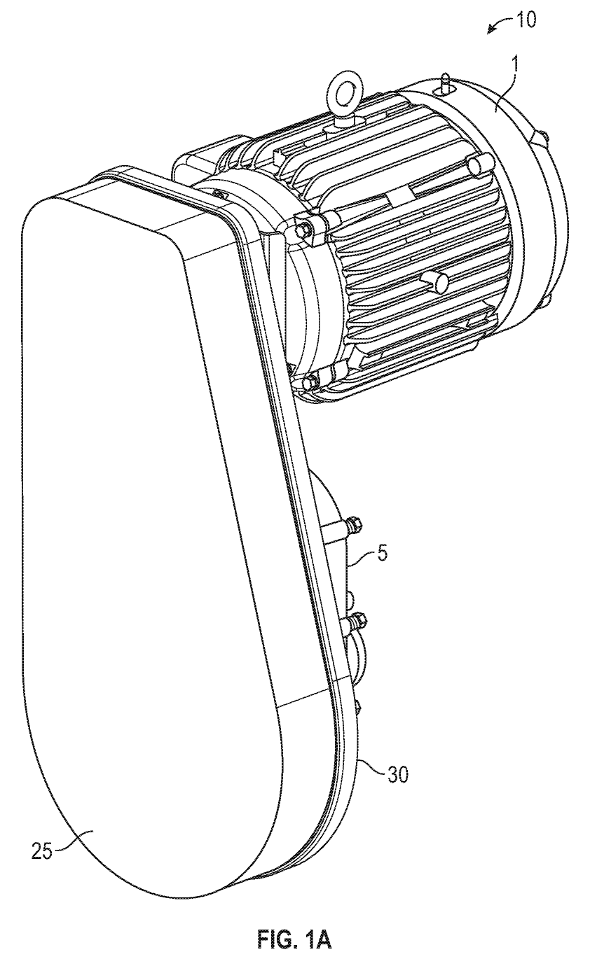

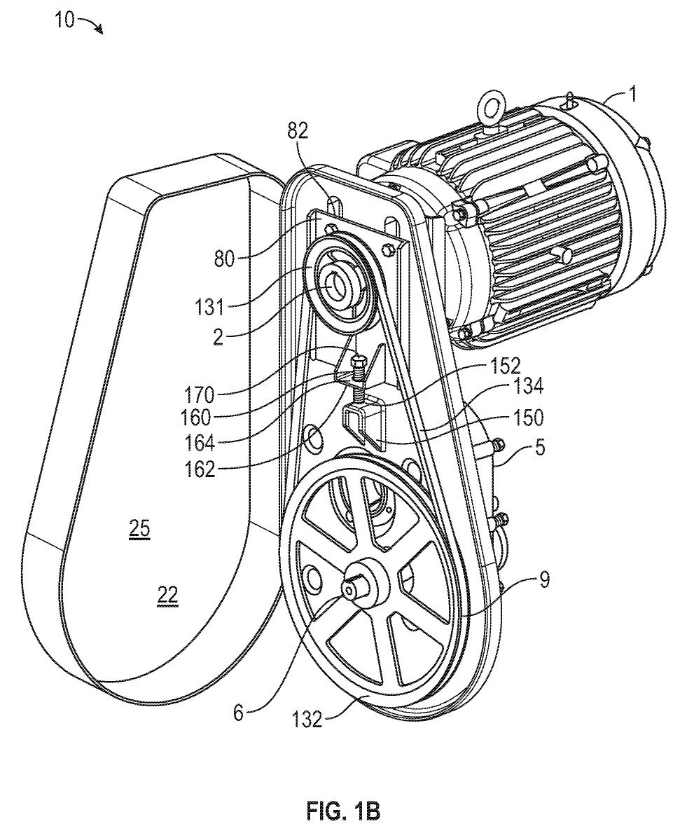

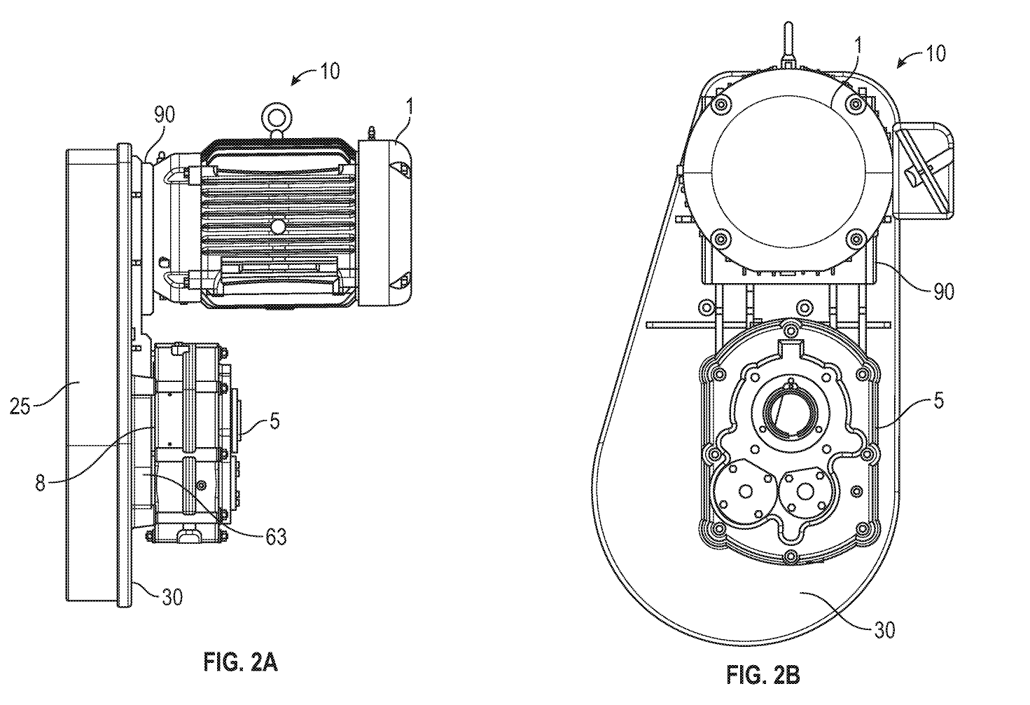

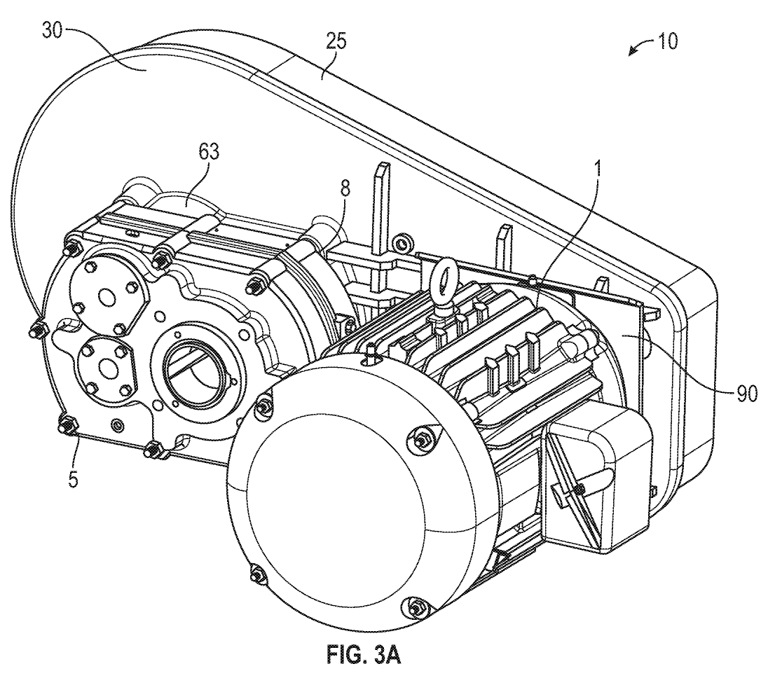

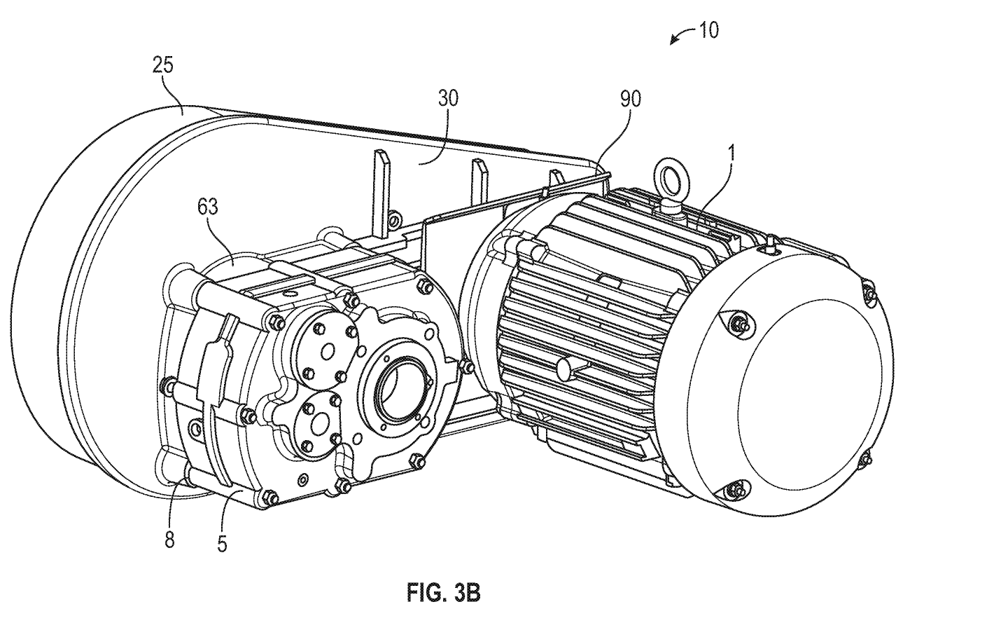

In one aspect, and as exemplarily illustrated in FIGS. 1 - 8 in a first embodiment, the back plate 30 of the mount housing is formed from a substantially planar back member 32 that has a first lobe area 34 and a second lobe area 36. The back member 32 extends to a peripheral edge 33 where it is integrally joined with a side wall 38 that extends substantially transverse to the back member. The peripheral side wall 38 terminates in a planar surface 39 that is positioned in a common plane that is spaced from the planar back member at a desired distance. As exemplarily shown, the transition from the back member to the side wall can be curved in cross-section to increase the structural rigidity of the back plate 30.

In the first embodiment, the back member 32 can further define a plurality of elongated slots 40 in the first lobe 34 of the back member. In this embodiment, it is contemplated that one of the plurality of elongated slots 40 can comprise a drive slot 42 that is configured to receive, without binding or interference, the drive shaft 2 of a coupled driving device 1. It is contemplated that the longitudinal axis L_{DS} of the drive slot will extend along a machine direction MD of the back plate 30. The plurality of elongated slots 40 further includes a pair of opposed elongated mount slots 44 that are positioned such that the drive slot 42 is positioned between, and preferably centered between, the mount slots 44 forming the respective pair of mount slots.

In aspects, each of the mount slots 44 can have substantially the same elongate length. Further, as exemplarily shown, each of the mount slots 44 can have an elongate length that is greater than the elongate length of the drive slot 42 and each of the mount slots can be configured to extend along an axis parallel to the longitudinal axis L_{DS} of the drive slot.

In embodiments, the back member 32 can further define at least one opening 46 in the second lobe 36 of the back member. In this aspect, it is contemplated that the at least one opening will comprise a drive opening that is configured to receive, without binding or interference, the driven shaft 6 of a coupled driven device 5.

As shown in the figures, to provide for mounting of the respective driving device 1 and the driven device 5, the exterior surface 48 of the back member can define a plurality of mounts 50 and a plurality of ribs 60 that extend outwardly to desired heights. The mounts 50 and the ribs 60 are formed to aid in the structural rigidity and bending resistance of the back plate in operation. Further, it is contemplated that portions of the respective mounts and ribs 50, 60 can act as guard structures that provide for compliance with applicable OSHA/MSHA rotating equipment guarding standards that require a guard to be placed around at least any exposed rotational aspects of the driving and driven devices as a means of guarding or preventing a person's body or clothing from coming into contact with such rotating.

In one aspect, and as exemplarily illustrated in FIGS. 1 – 2 , 4 - 5B, and 7 – 8, four mounts 50 are provided in the second lobe 36 of the back member. As one will appreciate, the number of mounts 50 provided and the respective positioning of those mounts is dependent upon the design of the driven devices, i.e., how many case fasteners, e.g., bolts and their respective orientations on the conventional driven device 5 that the operator will use to operatively couple the driven device to the back plate.

As shown, each mount 50 extends outwardly to a desired height from the exterior surface 48 of the back member and terminates in a planar surface 52 that defines an opening 53 that is sized and configured for receipt of a fastener, such as, for example and without limitation, a case fastener, e.g., a bolt and the like. As one skilled in the art will appreciate, it is contemplated that the plurality of mounts 50 will be positioned in an array that is shaped to mirror the array of recesses of the driven device 5 such that respective threaded fasteners can extend from an interior surface respective mounts 50 to operatively couple the driven device 5 to the back plate. As shown, the driven device 5 can be operatively coupled to the back plate to ensure the rigid connection of the driven device 5 to the back plate 30 and to ensure that at least a portion of the driven shaft 6 of the coupled driven device can be positioned within the interior cavity of the mount housing.

In aspects, the plurality of ribs 60 in this example can comprise a plurality of mount ribs 62 that extend outwardly to a desired height from the exterior surface 48 of the second lobe 36 of the back member. In one exemplary aspect, it is contemplated that each mount rib 62 can be configured to extend between respective spaced mounts 50 such that the respective ends of respective mount ribs 62 can be integrally formed with the adjoining mounts. In a further optional aspect, the mount ribs 62 can also extend to the substantial height of the adjoining mounts 50. Further, it is contemplated that at least a portion of the mount ribs 62 can have a curved profile when viewed from a top elevational viewpoint.

As exemplarily configured, the mounts 50 and the mount ribs 62 can form a ring structure 63 that aids in minimizing the deflection of the back plate under operative stresses. As shown, the formed ring structure 63 is shaped to surround the at least one opening in the second lobe and extends outwardly from the exterior surface of the back member to a desired distance. In embodiments, and as shown, distal portions of the ring structure are configured for mounting of the driven device such that a proximal portion of the driven shaft is enclosed in an interior void created by a face of the driven device, an interior wall structure of the ring structure, and a portion of the exterior surface of the back member that is bounded by the interior wall of the ring structure. Thus, it is contemplated that the formed ring structure can further act as a guard structure that provide for compliance with applicable OSHA/MSHA rotating equipment guarding standards that require a guard to be placed around at least any exposed rotational aspects of the driving and driven devices as a means of guarding or preventing a person's body or clothing from coming into contact with such rotating aspects.

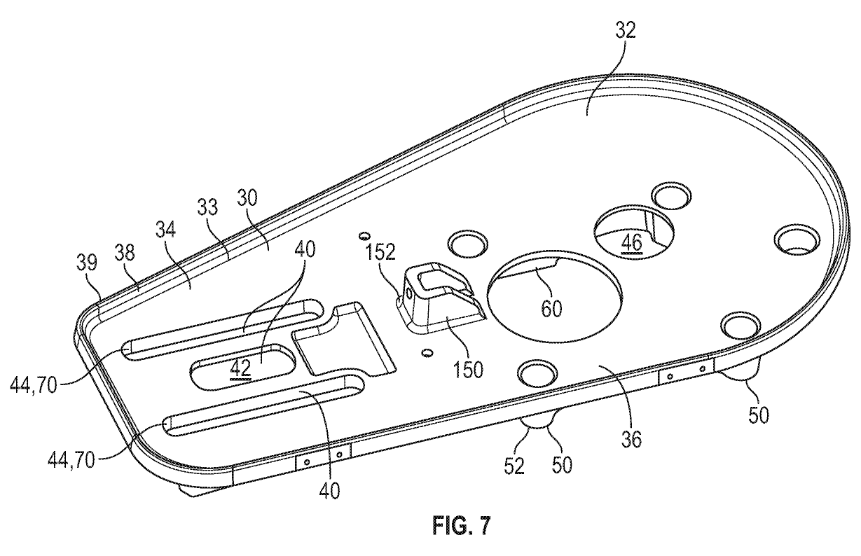

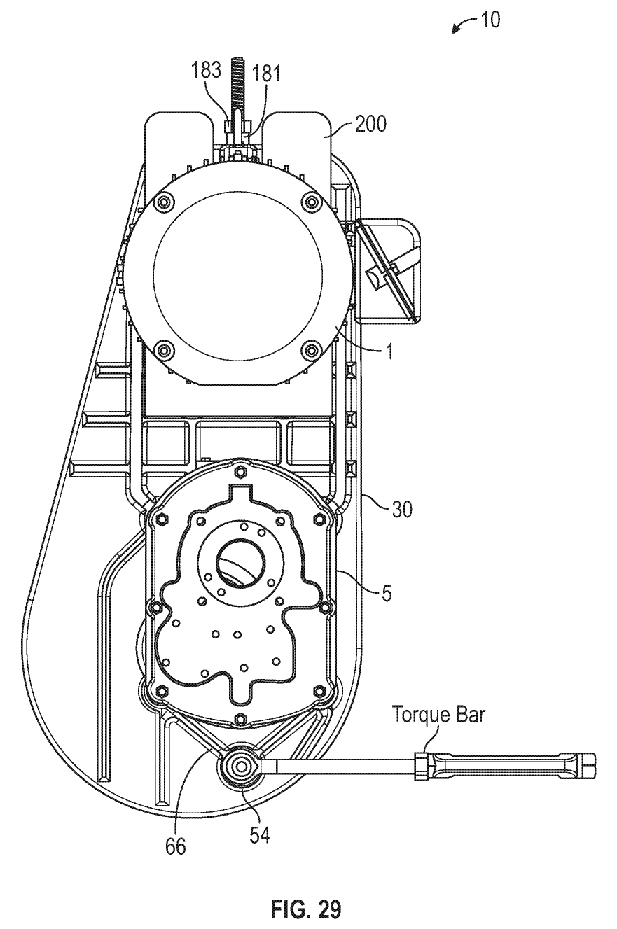

In another embodiment, and as shown in FIG. 8, the plurality of mounts can optionally include a bar mount 54 that is positioned toward the peripheral edge 33 of the second lobe 36 of the back member and a plurality of bar mount ribs 64 can be provided that respectively extend therebetween the bar mount 54 and a pair of respective adjoining mounts 50. In this aspect, and as exemplarily shown in FIG. 29, the bar mount can be configured to be operatively coupled to a conventional torque bar or arm.

In one optional aspect, and as exemplarily illustrated in FIGS. 1A - 2B, 4 - 5B, and 7 – 8, the plurality of ribs 60 can further include an array of ribs 66 extending outwardly to a desired height from the exterior surface 48 of the first lobe 34 of the back member. As shown, it is contemplated that the array of ribs 66 can include at least one rib 67 extending parallel to the machine direction of the back plate 30 and at least one integrally connected rib 68 extending transverse to the machine direction of the back plate. In further optional aspects, the ribs forming the array of ribs 66 can extend to a common desired height or can extend to differing desired heights. In other optional aspects, at least one rib forming the array of ribs 66 can have a height that varies along the elongate length of the respective rib.

As shown, the array of ribs 66 can further define an opposed pair of elongate wall structures 69 than extend generally about the respective pair of elongated mount slots 44 that are defined in the back member 32 of the back plate. Thus, as exemplarily illustrated, each elongated mount slot 44 and the respective integrally formed wall structure 69 form a shaped mount well 70 having a longitudinal axis that extends parallel to the machine direction of the back plate 30. As contemplated, the respective portion of the ribs 66 that are positioned about the two formed mount wells 70 have respective distal ends 71 that form respective planar mounting surfaces 72 that are positioned in a common plane that is parallel to the plane of the exterior surface 48 of the back plate.

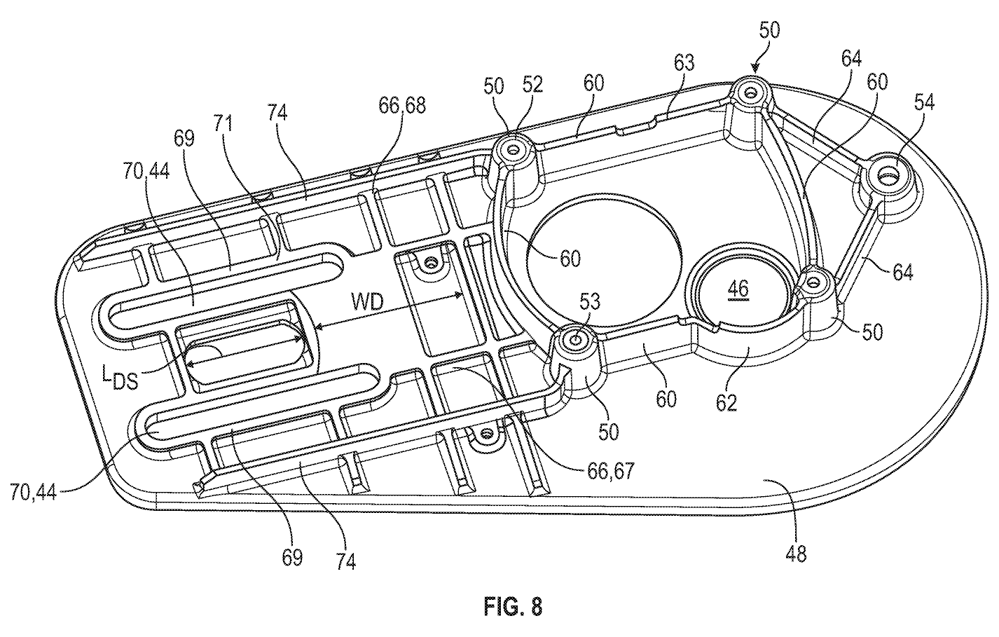

Optionally, and as exemplarily shown in FIGS. 8 and 9, the array of ribs 66 can include an opposed pair of wall ribs 74 that can extend generally parallel to and be spaced outwardly from the two formed mount wells 70. In exemplary aspects, the opposed pair of wall ribs 74 can be positioned adjacent to the peripheral edge 33 of the exterior surface 48 and can, optionally, have a height that is greater than the height of the ribs forming the remaining ribs of the array of ribs 60.

As shown in FIG. 9, in one embodiment, it is contemplated that the driving device 1, such as the exemplified c-faced electric motor, can be configured to be spaced from desired portions of the formed mounting surfaces 72 of the formed mount wells 70 such that at least a portion of the drive shaft 2 of the driving device 1 is positioned therein the interior cavity of the mount housing. In this embodiment, the planar face of the driving device, such as the exemplified c-faced electric motor, can be configured to be spaced from select portions of the formed mounting surfaces of the back member when the fasteners are secured such that a portion of the drive shaft 2 of the driving device 1 extends through the drive slot 42 and into the interior cavity of the mount housing.

In this aspect, and as shown in FIG. 9, it is contemplated that a first mount plate 80 can be positioned to overly an interior surface of the back member 32 in opposition to the positioning of the machine interface 3 of the exemplified c-faced electric motor such that conventional fasteners can securely space the relative position of the machine interface 3 of the exemplified c-faced electric motor relative to the bottom surface of a first mount plate 80 when the fasteners are secured through the formed mount wells and into engagement with the threaded recesses 4 in the machine interface 3 of the exemplified c-faced electric motor.

As one will appreciate, cylindrical sleeve spacers 11 can be provided that allow for the passage of the fasteners. In this aspect, it is contemplated that the cylindrical sleeve spacers 11 can affect the desired spaced relationship of the respective first mount plate to portions of the underling back member while also allowing for selective positioning of the driving shaft 2 of the driving device relative to the machine direction of the back plate 30. Each sleeve spacer defines an elongate central core that is shaped and configured for slidable receipt of a fastener. Further, each sleeve spacer has an outer diameter that is less than the width of the formed mount wells while having an operative diameter that restricts movement of the sleeve spacer such that the sleeve spacer will move generally along the longitudinal axis of the mount wells.

In operation, it is contemplated that the operative depth of the sleeve spacers can be, in one aspect, greater than the effective depth of the formed mount wells 70 in the back face 32. In embodiments, the operative depth of the depth of the sleeve spacers 11 can be greater than the effective depth of the formed mount wells 70 in the back face 32 to allow for axial movement of the first mount plate and the engaged driving device without frictional engagement to the respective opposing surfaces of the mount wells. In this exemplary aspect, when the first mount plate is engaged to the driving device and the fasteners, with the sleeve spacers, are positioned therein the mount wells, it is contemplated that the machine interface 3 of the exemplified c-faced electric motor will be spaced relative to the bottom surface of a first mount plate 80 at a desired distance that exceeds the operative depth of the formed mount wells 70 by less than 0.1 inch, preferably less than 0.05 inch, and more preferably less than 0.015 inch.

In this exemplary embodiment, the driving device 1, such as the exemplified c-faced electric motor, can be configured to be operatively coupled to portions of the first mount plate 80 that is positionable on the opposing interior surface of the back member 32. As one skilled in the art will appreciate, in this aspect it is contemplated that the first mount plate 80 can define a plurality of openings 82 that are positioned in an array that is shaped to mirror the array of threaded recesses 4 of the machine interface of the driving device 1. In this aspect, the first mount plate further defines a drive opening 83 shaped to allow for the receipt of the drive shaft 2 of the driving device 1.

In one exemplary aspect, the array formed by the plurality of openings 82 can have a first plurality of openings 82’ that are spaced from a second plurality of openings 82” at a distance that is substantially the same as the distance that separates the respective pair of opposed elongated mount slots 44. In this aspect, each of the respective axis of the first plurality of openings 82’ and second plurality of openings 82” can be positioned along respective longitudinal axis that are substantially the same as the same as longitudinal axis of the respective pair of opposed elongated mount slots 44 such that, in operation, the respective first plurality of openings 82’ and second plurality of openings 82” can be positioned to overlie the respective pair of opposed elongated mount slots 44. Further, it is contemplated that the distance between the openings of the respective first plurality of openings 82’ and second plurality of openings 82” can have a dimension that that is shorter than the elongate length of the pair of opposed elongated mount slots 44 to allow the first mount plate, with the fasteners extending though the plurality of openings 82, to be selectively moved along the machine axis of the back plate 30. As exemplarily shown in the figures, each of the respective first plurality of openings 82’ and second plurality of openings 82” can comprise a pair of spaced openings that are resultingly positioned in the 2X2 array of opening 82 about the drive opening 83.

Operatively, in this aspect, the respective threaded fasteners can be positioned to extend from an interior surface 84 of the first mount plate 80, though the plurality of openings 82 of the first mount plate, though the sleeve spacers and through the formed mount wells 70 of the back member, and into threaded contact with the array of threaded recesses 4 in the machine interface 3 of the driving device 1. As one will appreciate in this embodiment, upon engagement of the fasteners with the array of threaded recesses 4, the driving device 1 can be operatively allowed to move along the machine direction as desired to affect the desired tensioning of the drive belt.

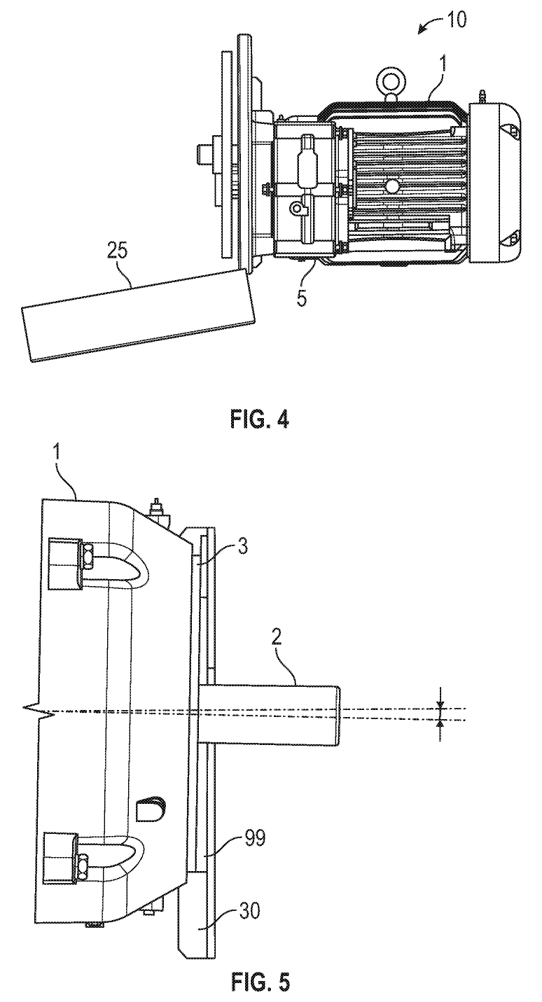

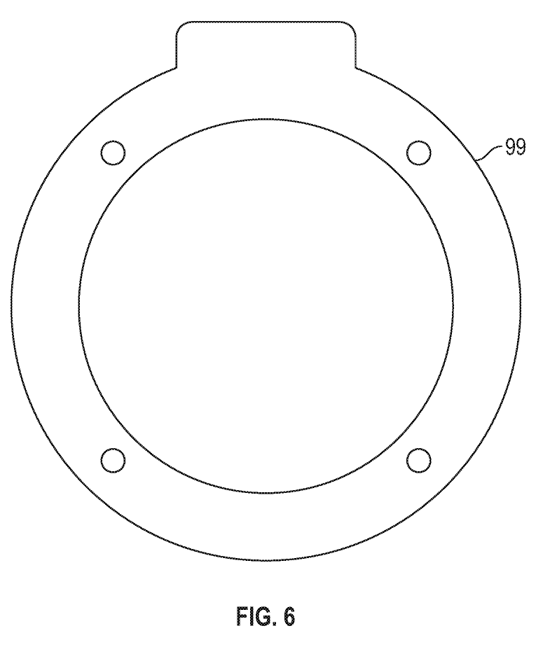

In an optional aspect, and as shown in FIG. 6, a shim 99 that has a cross-sectional width that tapers along the vertical axis of the shim can be positioned between the driving device and the select portions of the formed mounting surfaces of the back plate such that the drive shaft of the driving device that is enclosed therein an interior cavity of the mount housing can be offset at a desired angle. This allows for the drive shaft to be positioned at a desired angle with respect to the exterior surface 48 of the back plate as the weight of the driving device acts relative to the back plate.

In a further embodiment and as exemplarily shown in FIGS. 1B – 3B, and 10 – 11, the exemplified c-faced electric motor, can be configured to mount to portions of a second mount plate 90. In operation, it is contemplated that a bottom surface 91 of the second mount plate 90 can be positioned in spaced opposition to the first mount plate 80 and portions of the mounting surfaces 72 of the formed mount wells 70 such that a portion of the drive shaft 2 of the driving device 1 extends through the drive slot 42 and into the interior cavity of the mount housing.

As one skilled in the art will appreciate, in this aspect it is contemplated that the second mount plate 90 can define a plurality of openings 92 that are positioned in an array that is shaped to mirror the array of the plurality of openings 82 of the first mount plate 80. In this aspect, the second mount plate further defines a drive opening 93 shaped to allow for the receipt of the drive shaft 2 of the driving device.

Operationally in this embodiment, it is contemplated that a bottom surface 86 of the first mount plate 80 can be positioned to overlie a portion of the interior surface of the back member and to be positioned in opposition to the second mount plate 90 such that conventional fasteners, in conjunction with the sleeve spacers 11, can fix the spaced position of the first mount plate 80 relative to the second mount plate 90 when the fasteners are secured through sleeve spacers and the formed mount wells 70 to affect the desired spaced engagement of the respective mounting plates 80 and 90 while allowing for selective positioning of the driving shaft 2 of the driving device 1 along the machine direction of the back plate and relative to the driven shaft 6 of the driven device 5.

As one will appreciate, the sleeve spacers can allow for the creation of the desired spaced relationship of the respective first mount plate to the opposing second mount plate while also allowing for selective positioning of the driving shaft 2 of the driving device relative to the machine direction of the back plate 30. In operation, it is contemplated that the operative depth of the sleeve spacers can be, in one aspect, greater than the effective depth of the formed mount wells 70 in the back face 32.

In embodiments, the operative depth of the sleeve spacers can be greater than the effective depth of the formed mount wells 70 in the back face 32 to allow for axial movement of the first mount plate and the engaged driving device without frictional engagement to the respective opposing surfaces of the mount wells. In this exemplary aspect, when the first mount plate and the second mount plate are engaged to the driving device and the fasteners, with the sleeve spacers, are positioned therein the mount wells, it is contemplated that a bottom surface of the second mount plate 90 will be spaced relative to the bottom surface of a first mount plate 80 at a desired distance that exceeds the operative depth of the formed mount wells 70 by less than 0.1 inch, preferably less than 0.05 inch, and more preferably less than 0.015 inch.

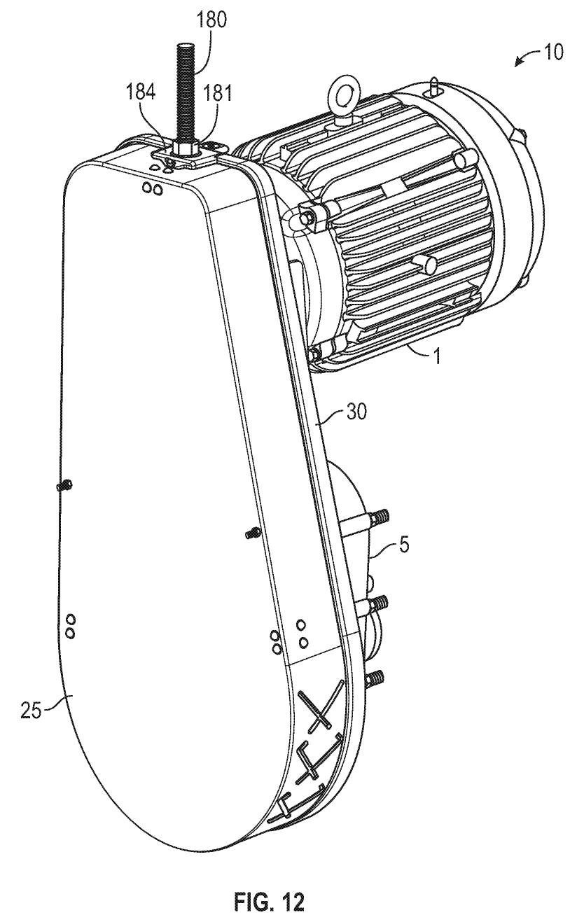

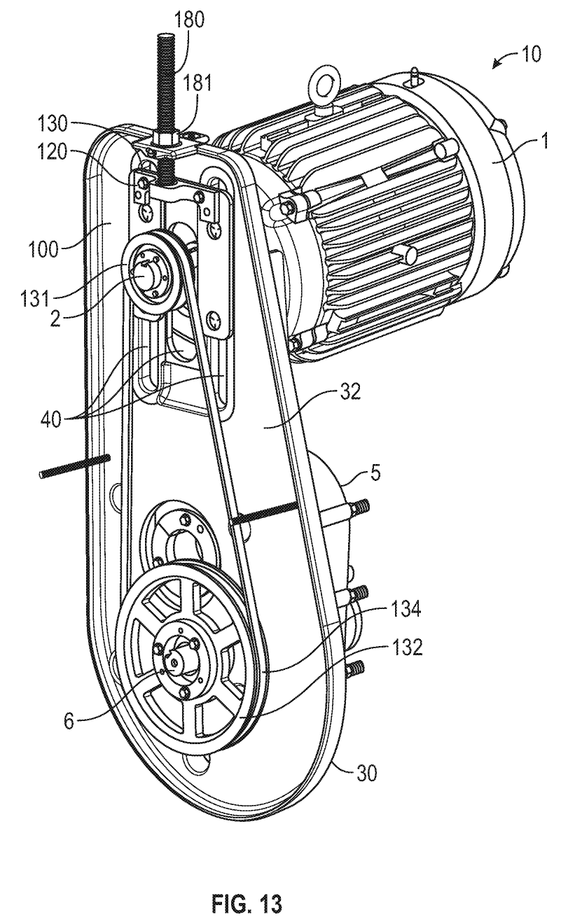

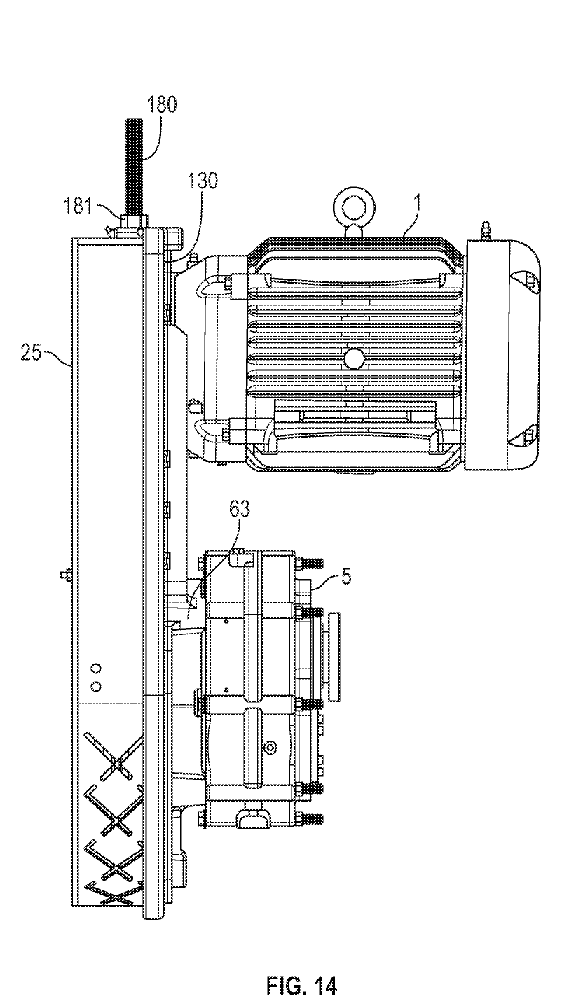

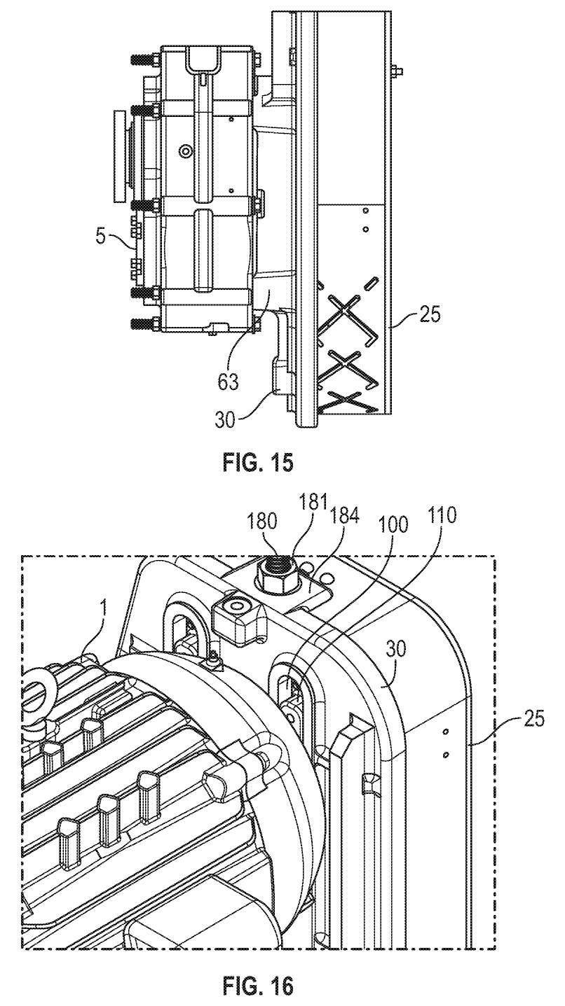

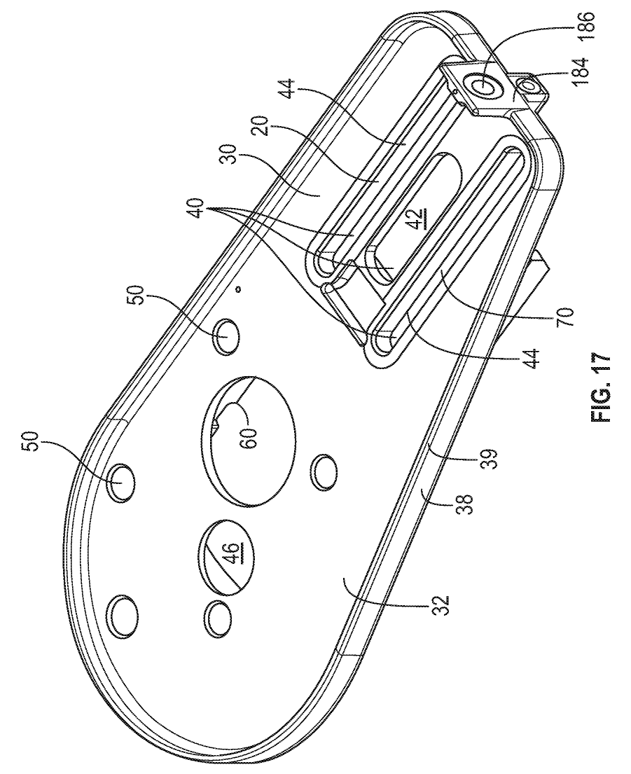

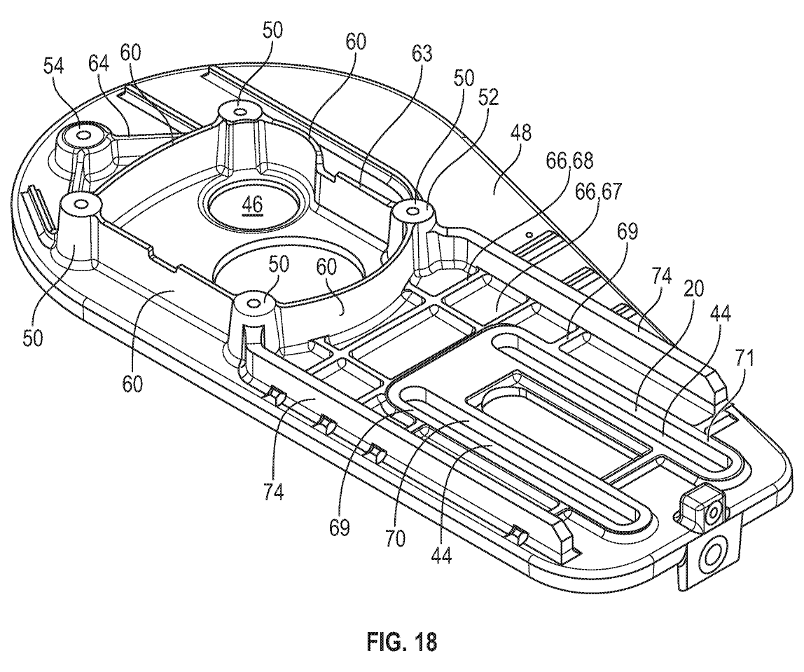

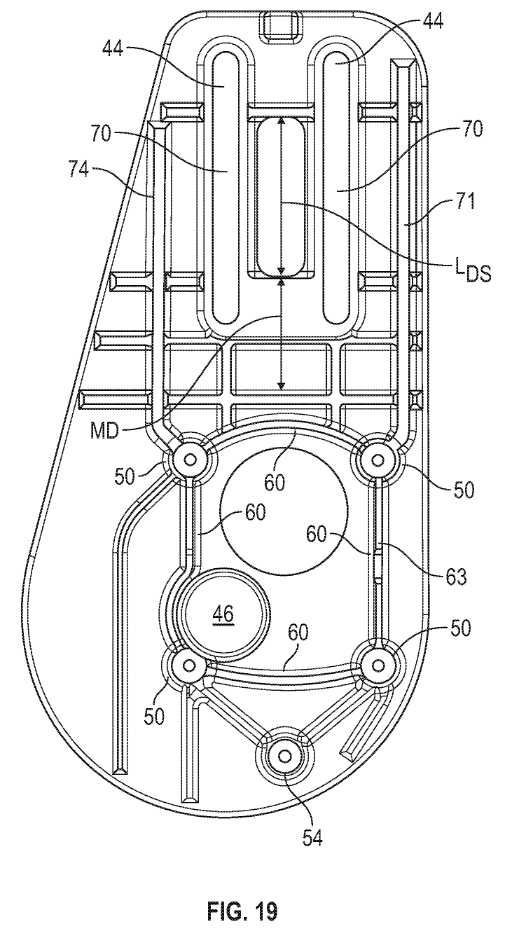

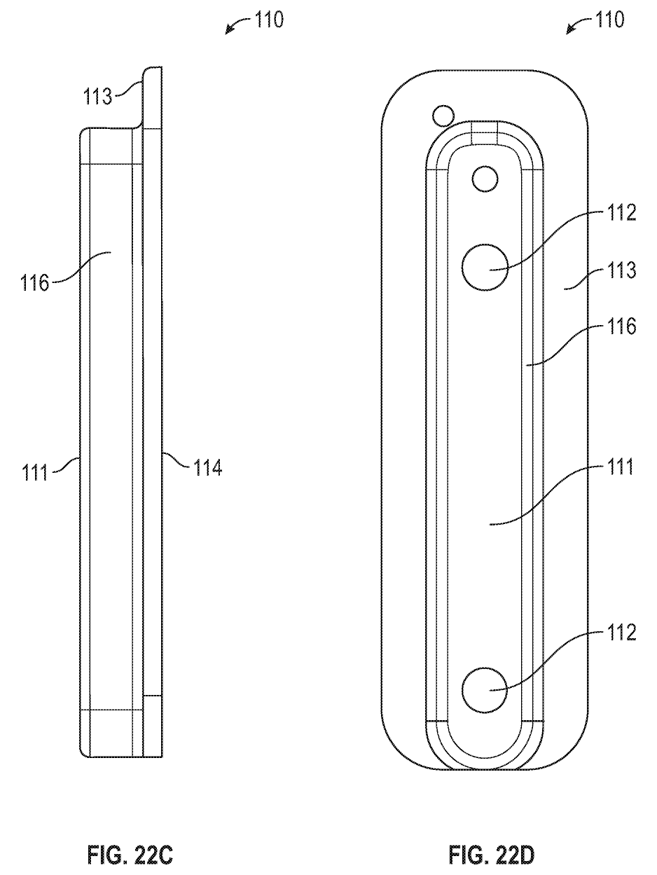

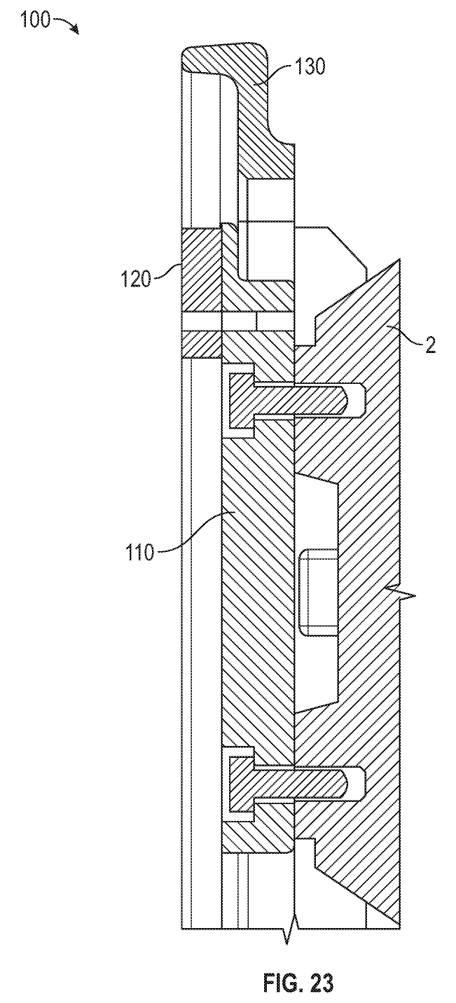

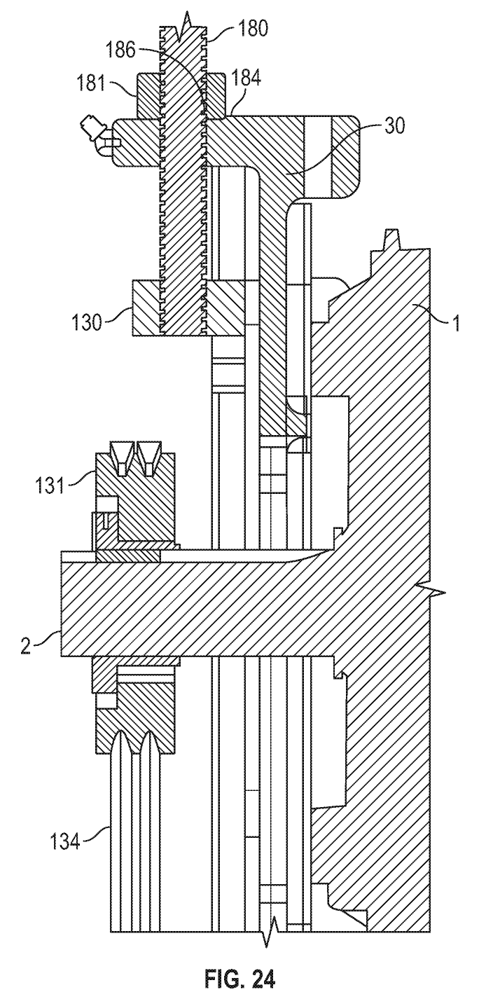

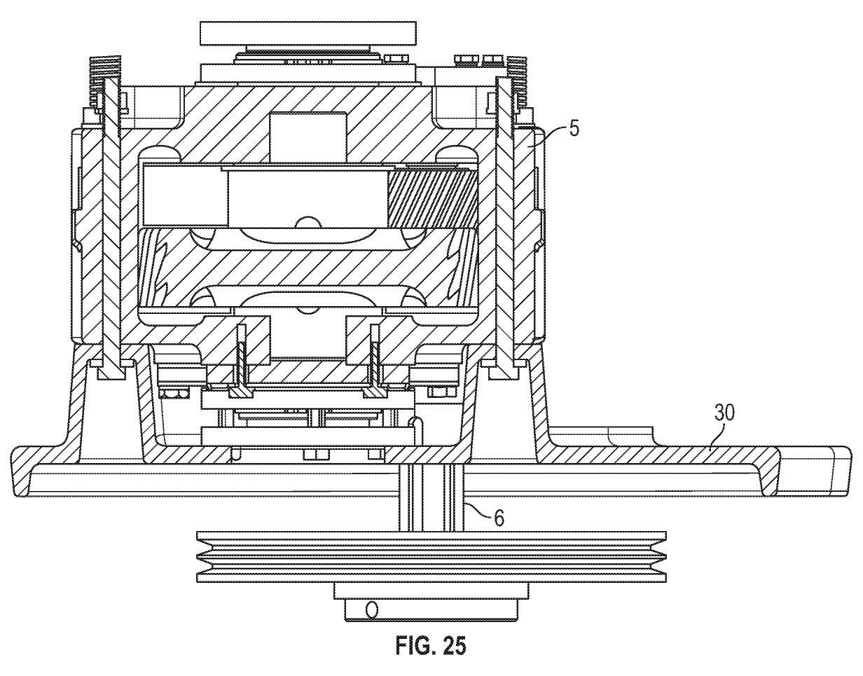

In a further embodiment and as exemplarily shown in FIGS. 13, 16, 20, 21, 23, and 24, it is contemplated that the driving device 1, such as the exemplified c-faced electric motor, can be configured to be coupled to desired mount surfaces 111 of a mount assembly 100 having a pair of spaced mount members 110 having a distal end portions 116 that are shaped for receipt therein the respective formed mount wells 70 of the back member 32 such that a portion of the drive shaft 2 of the driving device 1 extends through the drive slot 42 and into the interior cavity of the mount housing. This operation permits the driving device 1 and the associated position of the driving shaft 2 of the driving device to be selectively positionable along the machine direction of the back member 32. As discussed in more detail below, this feature allows the operator to effect desired tensioning of the belt drive.

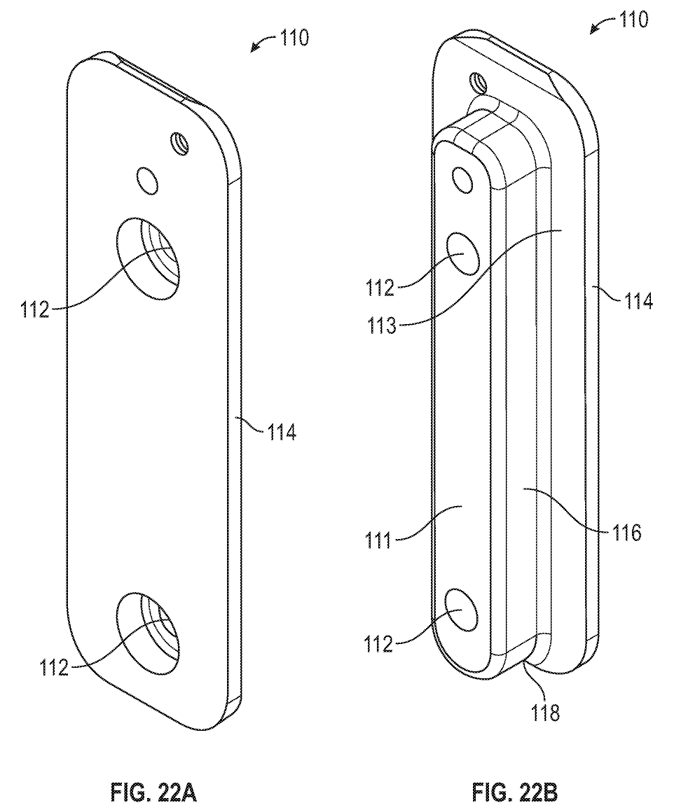

In this exemplary embodiment, and referring to FIGS. 22A – 22D, the distal end portion of each mount member 110 of the mount assembly terminates at a substantially planar mount surface 111 and has an elongate length that is less than the elongate length of the formed mount wells 70. Further, each mount member 110 of the mount assembly defines a pair of openings 112 that extend though the depth of the mount member and that are configured for operative receipt of a fastener. As one skilled in the art will appreciate, in this aspect it is contemplated that the respective pairs of openings 112 of the pair of spaced mount members 110 can be positioned in an array that is shaped to mirror the array of threaded recesses 4 of the machine interface of the driving device 1.

Each mount member 110 further includes a shoulder member 114 coupled to the proximal end 118 of the distal end portion 116 that defines a shoulder surface 113. In this aspect, the shoulder surface 113 has a width and length that is greater than the elongate length and width of the distal end portion 116 of the mount member 110. In operation, it is contemplated that the operative depth of the distal end portion 116 that extends between the shoulder surface 113 and the mount surface 111 can be, in one aspect, greater than the effective depth of the formed mount wells 70 in the back face 32.

In embodiments, the operative depth of the distal end portion 116 that extends between the shoulder surface 113 and the mount surface 111 can be greater that the effective depth of the formed mount wells 70 in the back face 32 to allow for axial movement of the mount assembly without frictional engagement of the mount assembly to the respective opposing surface of the mount wells. In this exemplary aspect, when the mount members are positioned therein the mount wells, it is contemplated that the mount surfaces 111 of the mount members 110 can be spaced above the formed mounting surfaces 72 of the formed mount wells 70 at a desired spacing which is less than 0.1 inch, preferably less than 0.05 inch, and more preferably less than 0.015 inch. In operation, it is contemplated that in the operative secured position, the weight of the driving device 1 acting on the respective mount members 110 will axially tilt the mount member relative to the formed mounting surfaces 72 of the formed mount wells 70 at an acute angle that is less than 2 degree, less than 1 degree, preferably less than 0.5 degree, and more preferably less than 0.2 degree.

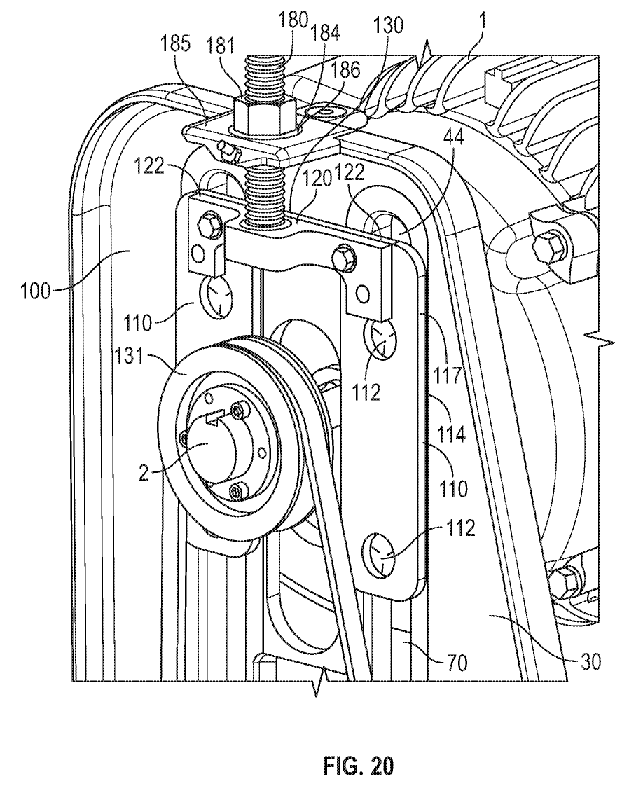

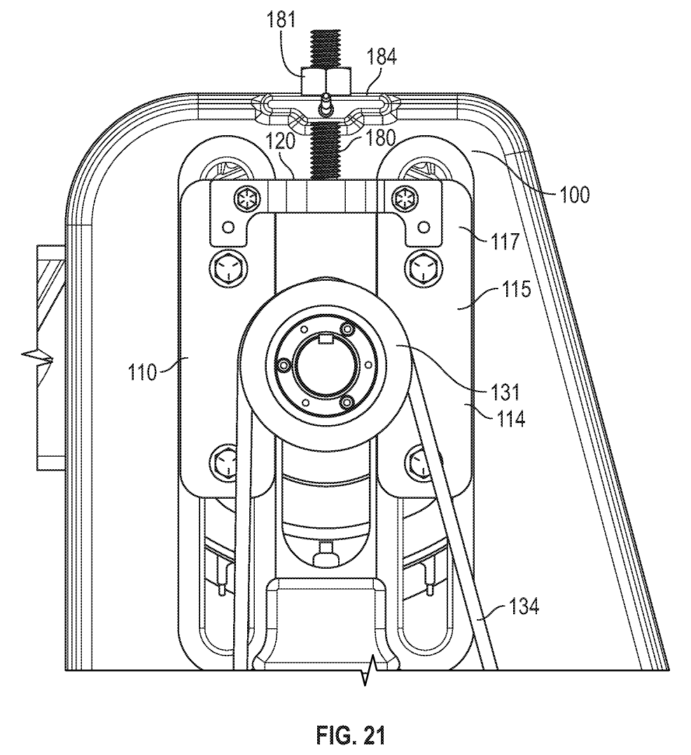

In a further aspect, and as shown in FIGS. 20 and 21, the mount assembly 100 further includes a bridge member 120 having a central portion 130 and opposing end portions 122 that are coupled to the outer surface 115 of the respective shoulder members 114 of the mount members 110. As shown, it is contemplated that each end portion 122 of the bridge member 120 can be connected to an upper portion 117 of the shoulder member 114 and be spaced from the pair of openings 112 such that the respective end portion 122 can be positioned adjacent to the peripheral edge of the upper portion 117 of the shoulder member.

As exemplarily shown, the bridge member 120 can be fixedly connected to the respective mount members 110 via the use of conventional fasteners, such as the exemplary bolt shown in the figures. However, it is also contemplated that the bridge member 120 can be integrally formed with the respective mount members 110.

Operationally in this embodiment, it is contemplated that the shoulder surfaces 113 of the shoulder members 114 can be positioned to overlie a portion of the interior surface of the back member such that the mount members 110 are operatively received therein the mount wells 70 and such that the mount surfaces 111 are positioned adjacent the mounting surfaces 72 of the formed mount wells 70 as described herein. As one skilled in the art will appreciate, conventional fasteners can be used securely mount the driving device 1 to the mount surfaces 111 of the mount members 110 when the fasteners are secured through the respective pairs of openings 112 of the pair of spaced mount members 110 and into operative engagement with the array of threaded recesses 4 of the machine interface of the driving device 1. One skilled in the art will appreciate that the mount assembly 100 and the coupled driving device 1 can be selectively positioned axially relative to the back plate 30 as desired along the respective mount wells and relative to the machine direction of the back plate. This also allows for selective positioning of the driving shaft 2 of the driving device 1 along the machine direction of the back plate and relative to the driven shaft 6 of the driven device 5.

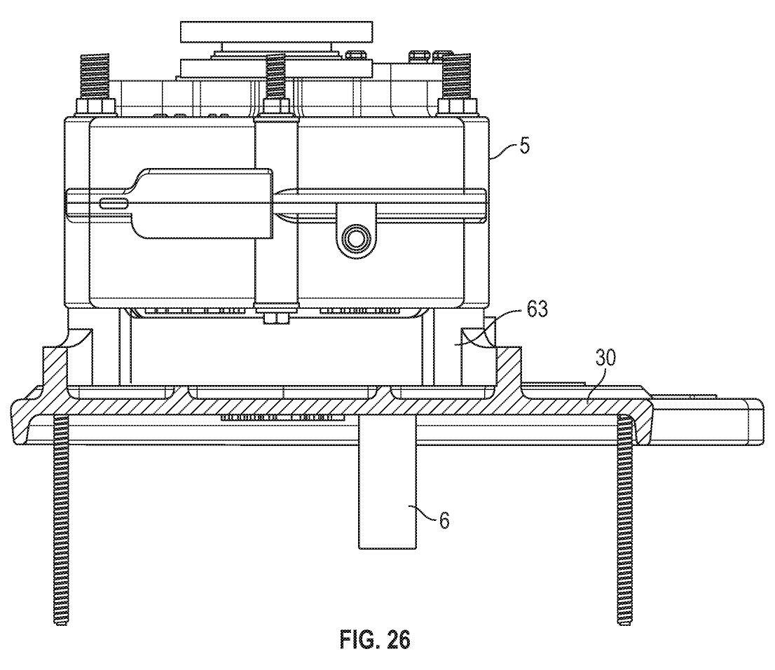

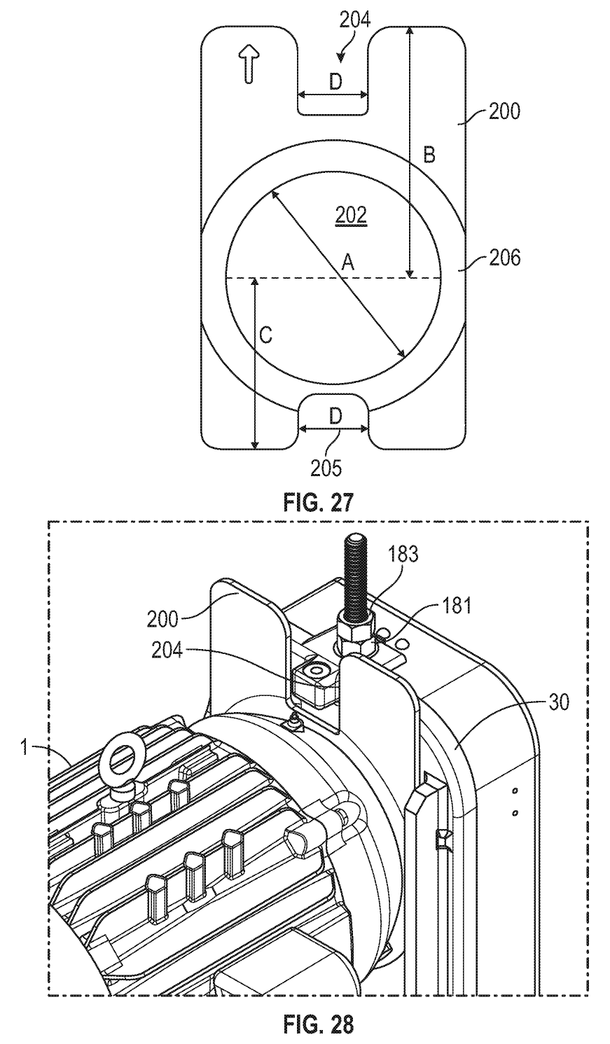

Optionally, and as shown in FIGS. 27 - 29, the drive mount system 10 can further include a guard member 200 defining a central opening 202, an upper slot 204, and a lower slot 205. In one aspect, the guard member 200 can have a general planar shape and can further define a mount surface 206 surrounding the central opening that is sized and shaped to allow for positioning thereon a complementary face surface of a driving device such as the exemplified conventional c-faced electric motor. As exemplified in FIG. 27, it is contemplated that dimension A can be selected to allow for the complementary mounting of the mount surface 206 thereon the complementary face surface of a driving device.

Operatively, the guard member 200 is configured to be positioned thereon the complementary face surface of the driving device 1, e.g. such as a conventional c-faced electric motor, and positioned relative to portions of the respective mount surfaces 111 of the mounting member 110 of the mount assembly such that the formed mount wells 70 in the back plate can be operatively enclosed irrespective of where the mount assembly 110 is selectively positioned within the mount wells with respect to the machine direction of the back plate. In this aspect, and as shown in FIG. 27, it is contemplated that dimensions B, C, and D can be selected to allow for the operable enclosing of the mount wells 70 of the back plate irrespective of where the mount assembly 110 is selectively positioned with respect to the machine direction of the back plate. In embodiments, it is contemplated that the coupled guard member can act as an additional guard structure that provides for compliance with applicable OSHA/MSHA rotating equipment guarding standards, which require a guard to be placed around at least any exposed rotational aspects of the driving and driven devices as a means of guarding or preventing a person's body or clothing from coming into contact with such rotating aspects.

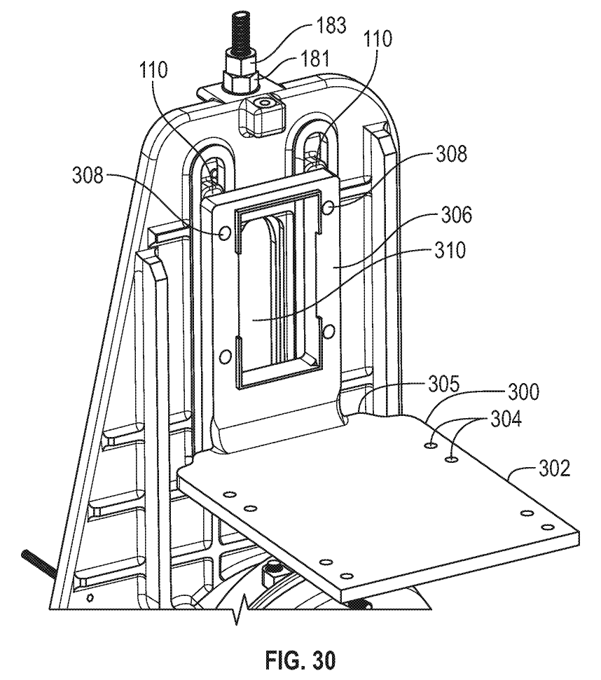

Optionally, and as shown in FIGS. 30 - 31, the drive mount system 10 can further include a L-shaped scoop support 300 that is configured to operatively support a driving device 1, e.g., such as an exemplified conventional foot mounted electric motor, that has a plurality of footings positionable in a common plane and a drive shaft 2 extending along an axis that is transverse to the common plane of the plurality of feet. In this aspect, it is contemplated that the scoop support 300 can have a lower surface 302 that defines a plurality of openings 304, which openings 304 are configured to receive fasteners that are shaped and sized to feed through respective bores defined in each of the footings such that the lower surface 302 of the scoop support 300 can be positioned parallel to the common plane of the footings when the conventional foot mounted electric motor is connected to the lower surface of the scoop support. It is further contemplated that the scoop support 300 can define a mount surface 306 that can be optionally integrally connected to a distal edge 305 of the lower surface 302 and extending transverse to the lower surface.

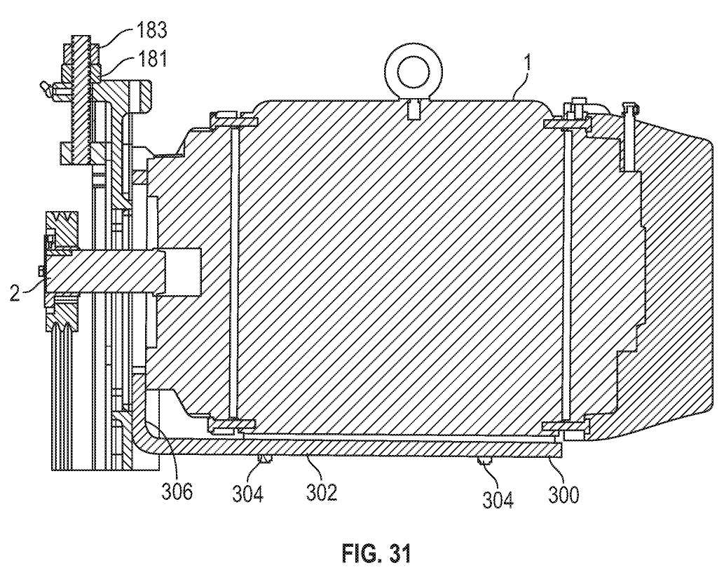

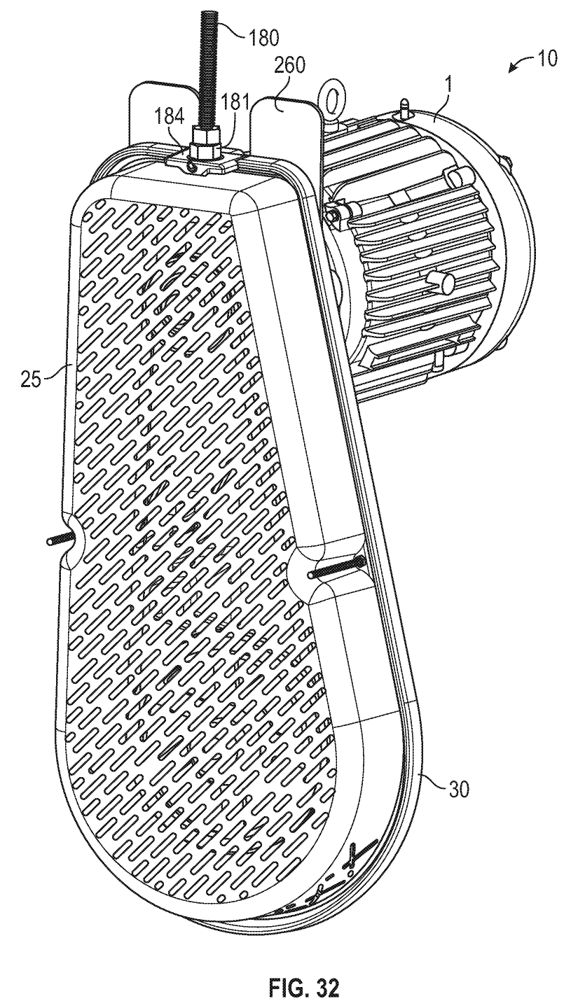

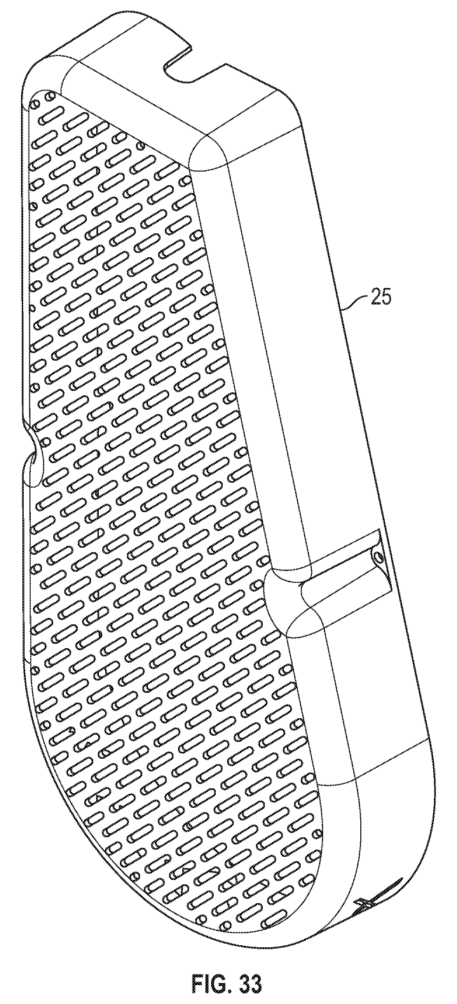

In one embodiment, and as shown in FIG. 31, it is contemplated that the mount surface 306 of the scoop support can have a plurality of threaded openings 308. In this embodiment, the plurality of threaded openings 308 of the mount surface are configured to be positionable in a coaxial relationship with the respective openings 112 of the pair of spaced mount members 110. As one skilled in the art will appreciate, in this aspect it is contemplated that the respective plurality of threaded openings 308 in the mounted surface of the scoop support can be positioned in an array that is shaped to mirror the array formed by the respective openings 112 of the pair of spaced mount members 110.

In an optional embodiment is contemplated that the mount surface 306 of the scoop support can have a plurality of openings 308 that are configured to be positionable in a coaxial relationship with the respective openings 112 of the pair of spaced mount members 110. In this aspect and as one skilled in the art will appreciate, it is contemplated that the respective plurality of openings 308 in the mounted surface of the scoop support can be positioned in an array that is shaped to mirror the array formed by the respective openings 112 of the pair of spaced mount members 110.

In operation, the mount surface 306 of the scoop support 300 can be mounted to the mount surfaces 111 of a mount assembly 100 such that a portion of the drive shaft 2 of the driving device 1, e.g., the exemplified conventional foot mounted electric motor, extends through the drive slot 42 of the back plate and a complementary bore 310 defined in the mount surface 306 of the scoop support and into the interior cavity of the mount housing. In one optional aspect shown in FIG. 31, the bore 310 defined in the mount surface can have a diameter that is greater than the diameter of the drive shaft 2.

In this aspect, it is contemplated that conventional fasteners can be used to securely space the relative position of driving shaft 2 of the exemplified foot mounted electric motor to the mount surface of the scoop support 300 when the fasteners are secured through the openings 112 of the pair of spaced mount members 110 and into engagement with the plurality of threaded openings of the mount surface of the scoop support or, optionally passing through the plurality of openings of the mount surface of the scoop support and into engagement with complementary nuts. One skilled in the art will appreciate that selective positioning of the respective mount members relative to the back member 32 permits the driving device 1 and the associated position of the driving shaft 2 of the driving device to be selectively positionable along the machine direction of the back member 32. As discussed in more detail below, this feature allows the operator to effect desired tensioning of the belt drive when the fasteners are loosened.

In embodiments, a first pulley 131 is coupled to the drive shaft 2 of the driving device 1 and a second pulley 132 is coupled to the driven shaft 6 of the driven device 5 with a belt drive 134 being positioned in contact with the respective first and second pulleys to effect transfer of rotational energy from the first pulley to the second pulley. As one skilled in the art will appreciate, the respective operative diameters of the respective first pulley 131 relative to the second pully 132 can be selected by the operator to determine the ratio of rotational energy that is transferred from driving shaft of the driving device to the driven shaft of the driven device. Typically, the diameter of the second pulley can be at or greater than the diameter of the first pulley, and preferably the diameter of the second pulley will be greater than the diameter of the first pulley. In other embodiments, the diameter of the second pulley can be less than the diameter of the first pulley.

In embodiments, means for selectively positioning of the driving shaft 2 of the driving device 1 along the machine direction of the back plate and relative to the driven shaft 6 of the driven device 5 are provided.

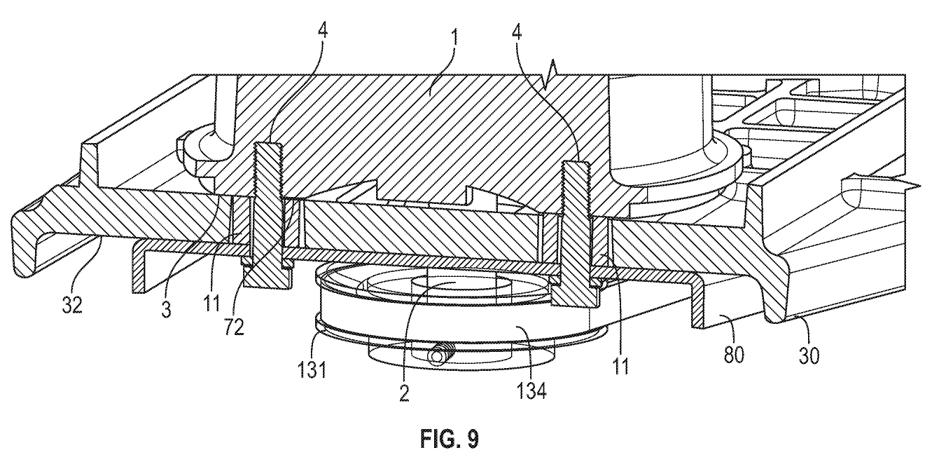

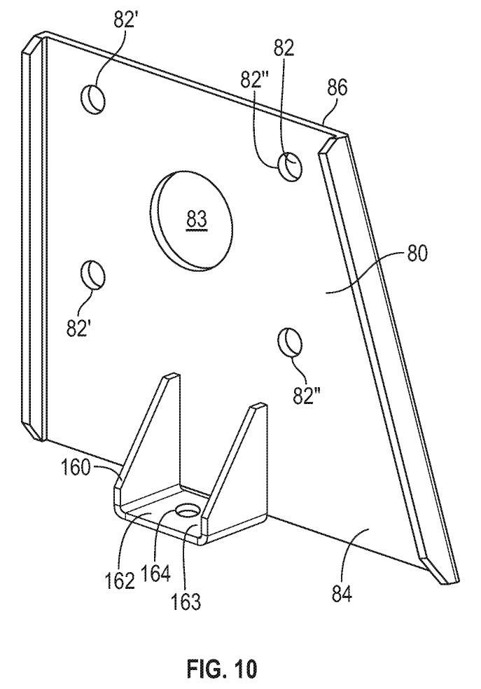

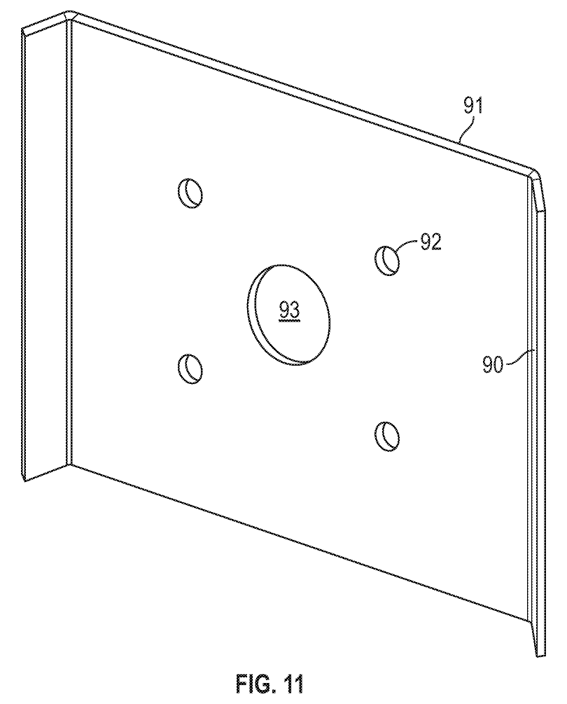

In one embodiment of a means for selectively positioning of the driving shaft 2 of the driving device 1 along the machine direction of the back plate 32 and referring to FIGS. 1B and 10, a ledge 150 can be defined in the interior surface of the back member 32 of the back plate 30 between the at least one drive opening in the back member and the drive slot of the back member. The ledge 150 can extend outwardly from the interior surface and can define a stop surface 152 that is positionable transverse to the interior surface of the back member and transverse to a longitudinal axis that extends coaxial to the machine axis defined by the drive slot of the back member. Further, and as shown in FIG. 10, the first mount plate 80 that is configured to be positioned in the interior cavity of the mount housing can also define a mount ledge member 160 that extends outwardly from the inner surface of the first mount plate and that defines a planar member 162 having an elongated threaded aperture 164 that is sized and shaped for complementary receipt of an elongated threaded bolt 170. The aperture 164 having an axis that is parallel to or co-axial with the machine axis of the back plate 130.

In operation, when the drive belt 134 is positioned thereon the respective first and second pulleys, the elongated threaded bolt 170 can be rotatably driven through the threaded aperture 164 of the planar member 162 of the mount ledge member 160 and into operative contact with the stop surface 152 of the ledge 150 of the back plate 30 until the first pulley mounted to the drive shaft is operatively spaced from the second pulley mounted to the driven shaft at an operative position along the machine axis that results in achievement of a desired degree of tensioning of the belt drive. Optionally, when the belt drive is tensioned as desired, at least one complementary nut can be secured to a proximal portion of the elongated threaded bolt 170 and can be operatively threaded down the threaded bolt and into contact with an upper surface 163 of the planar member 162 to ensure that the driving device 1 will not undesirably move from the operative position relative to the back plate 30.

Referring to FIGS. 20 – 21 and 23 – 24, in an alternative embodiment, a means is provided for selectively moving the pair of spaced mount members axially along the mount wells and relative to the machine direction of the back plate to obtain a desired distance between the driving shaft and the driven shaft that effects a desired level of tension in the rotating belt. In this aspect, in embodiments, the central portion 130 of the bridge member 120 of the mount assembly 100 can further include an elongated threaded rod 180 mounted to an upper portion 122 of the central portion of the bridge member. In this aspect, it is contemplated that the elongated threaded rod 180 can extend along an axis that is parallel to or co-axial with the machine axis of the back plate 30 when the mount members 110 of the mount assembly 100 are positioned therein the formed mount wells 70.

In this embodiment, a portion of the planar surface 39 of the peripheral side wall 38 of the back plate defines a ledge 184 that is positioned along the machine axis of the back plate and co-axial to the longitudinal axis of the drive slot of the back member. The ledge 184 can extend outwardly from the common plane of the peripheral side wall 38 of the back plate 30 and can define an upper surface 185 and an elongated bore 186 that is sized and shaped for complementary receipt of the elongated threaded rod 180. In this aspect, it is contemplated that the bore 186 can have an axis that is parallel to or co-axial with the machine axis of the back plate 130.

In operation, when the drive belt 134 is positioned thereon the respective first and second pulleys, a drive nut 181 that is complementarily sized and shaped to be operatively and rotatively received onto the elongated threaded rod 180 can be threaded onto the elongate threaded rod and brought into contact with the upper surface 185 of the ledge 184. As one will appreciate, continued rotation of the drive nut 181, in contact with the upper surface, about the elongated threaded rod 180 effects a corresponding axial movement of the elongate threaded rod relative to the upper surface of the ledge. Because the distal end portion of the elongated threaded rod 180 is fixedly coupled to the mount assembly, relative axial movement of the elongated rod 180 will result in corresponding movement of the mount assembly 100 along the machine axis of the back plate 30. Such axial movement of the mount assembly 100 along the machine axis of the back plate results in the complementary movement of the mount members 110 along the mount wells 70 and the complementary movement of the driving shaft 2 along the machine direction and relative to the driven shaft 5.

In one embodiment, when the first pulley 131 mounted to the drive shaft 2 is operatively spaced from the second pulley 132 mounted to the driven shaft 5 is placed in at an operative position along the machine axis that results in achievement of a desired degree of tensioning of the belt drive, it is contemplated that a lock nut 183, which is complementarily sized and shaped to be operatively and rotatively received onto the elongated threaded rod 180, can be threaded onto the elongate threaded rod and brought into contact with the upper surface of the drive nut 181 to selectively secured the desired tensioned position of the elongated threaded rod relative to the back plate to ensure that the driving device 1 will not undesirably move from the operative position relative to the back plate 30 when place in this operative position.

In one embodiment, when the first pulley 131 mounted to the drive shaft 2 is operatively spaced from the second pulley 132 mounted to the driven shaft 5 is placed in at an operative position along the machine axis that results in achievement of a desired degree of tensioning of the belt drive, it is contemplated that the drive nut 181 can be maintained in the desired position relative to the elongated threaded rod 180 through the use of a threadlock adhesive that can be applied to the juncture of the respective threads of the drive nut and elongated threaded rod. Such a threadlock adhesive can exemplarily include an anaerobic adhesive, which has a desired degree of resistance to loosening and movement from the desired position due to applied vibration on the drive mount system 10 and to optionally provide corrosion-resistant seals. Conventionally, such a threadlock adhesive can be selected to be removable upon application of a desired level of torque thereon the drive nut 181.

As one skilled in the art will appreciate, the drive mount system 10 of the present invention reduces complexity of assembly and improves ease of maintenance. When compared to the prior art guard and/or mount assemblies required for a conventional belt drive assembly, the present invention provides for a significant reduction in the number or parts or accessories that are required to create an OSHA/MSHA compliant drive mount system. With the front cover positioned in the closed position, the belt drive, pulleys and rotating drive/driven shafts of the respective drive and driven devices are enclosed within the interior cavity of the mount housing. One will appreciate that no additional guarding is required when the drive mount system is in an operative position with the front cover coupled to the back plate in the closed position and, optionally, with the guard member 200 positioned thereon the complementary face surface of the driving device 1 and positioned relative to portions of the respective mount surfaces 111 of the mounting member 110 of the mount assembly.

For maintenance, the drive mount system beneficially allows for belt tensioning via the operation of a means for selectively positioning of the driving shaft 2 of the driving device 1 along the machine direction of the back plate 32 and relative to the driven shaft 6 of the driven device 5. Further, instead of the removal of multiple, heavy guard and/or mount assemblies that are typically required for a conventional belt drive assembly, the present invention allows for ready access for maintenance and adjustment to the sheaves, belts, and bushings, and the like that are positioned in the interior cavity of the mount housing upon the simple removal or repositioning of the front cover from the closed position to an open position, which allows for clear access. Optionally, the front cover can be configured to be hinged to the mount housing for selective movement between the open and closed position. In a further aspect, it is contemplated that the front cover can be configured to be selectively removed from the mount housing for desired access to the internal cavity of the mount housing.

Still further, when compared to the prior art guard and/or mount assemblies required for a conventional belt drive assembly, the present invention can optionally provide for a significant reduction in the overall weight of the drive mount system, which aids in creating a safe work environment for installation and maintenance processes.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims.

What is claimed:

1. A drive mount system for operatively tensioning and enclosing a rotating belt drive operatively extending between a driving device and a driven device, comprising:
a mount housing having a back plate and a front cover that is selectably connected to the back plate to define an enclosed interior cavity when the front cover is selectively placed in a closed position relative to the back plate, wherein the back plate has a substantially planar back member that has a first lobe area and a second lobe area, wherein the back member defines a plurality of elongated slots in the first lobe of the back member, wherein one of the plurality of elongated slots is a drive slot that extends along a machine direction of the back plate and that is configured to receive a distal portion of a drive shaft of the driving device, wherein the plurality of elongated slots further includes a pair of opposed elongated mount slots that are positioned such that the drive slot is positioned between the mount slots forming the respective pair of mount slots, wherein each elongated mount slot forms a mount well having a longitudinal axis that extends parallel to the machine direction of the back plate, wherein each mount well has opposed mounting surfaces, wherein the back member further defines at least one opening in the second lobe of the back member that is configured to receive a distal portion a driven shaft of the driven device, wherein the exterior surface in the second lobe of the back member defines a ring structure that surrounds the at least one opening in the second lobe and that extends outwardly from the exterior surface of the back member, wherein distal portions of the ring structure are configured for mounting of the driven device such that a proximal portion of the driven shaft is enclosed in an interior void created by a face of the driven device, an interior wall structure of the ring structure, and a portion of the exterior surface of the back member that is bounded by the interior wall of the ring structure;
a mount assembly having a pair of spaced mount members having distal end portions that are shaped for receipt therein the respective formed mount wells, wherein each distal end portion terminates at a substantially planar mount surface and has an elongate length that is less than the elongate length of the formed mount well, wherein the mount surfaces of the mount members are spaced above the mounting surfaces of the formed mount wells at a desired spacing when the mount members are positioned therein the mount well; wherein the respective mount surfaces of the pair of spaced mount members are configured for mounting the driving device thereto such that the distal portion of the drive shaft of the driving device extends through the drive slot of the back member and into the interior cavity of the mount housing; and
a means for selectively moving the pair of spaced mount members axially along the mount wells and relative to the machine direction of the back plate to obtain a desired distance between the driving shaft and the driven shaft that effects a desired level of tension in the rotating belt.

2. The drive mount system of claim 1, wherein the driving device is a c-faced electric motor.

3. The drive mount system of claim 1, wherein each mount member of the mount assembly defines a pair of openings that extend though the depth of the mount member and that are configured for operative receipt of a fastener, and wherein the respective pairs of openings of the pair of spaced mount members are positioned in an array that is shaped to mirror an array of threaded recesses of a machine interface of the driving device.

4. The drive mount system of claim 3, further comprising a plurality of fasteners that are sized and shaped to securely mount the driving device to the mount surfaces of the mount members when the fasteners are secured through the respective pairs of openings of the pair of spaced mount members and into operative engagement with an array of threaded recesses defined in a machine interface of the driving device.

5. The drive mount system of claim 1, wherein each mount member further includes a shoulder member coupled to a proximal end of the distal end portion.

6. The drive mount system of claim 5, and wherein the shoulder member defines a shoulder surface having a width and length that is greater than the elongate length and width of the distal end portion of the mount member.

7. The drive mount system of claim 6, wherein the operative depth of the distal end portion that extends between the shoulder surface and the mount surface is greater than an effective depth of the formed mount wells in the back face to allow for axial movement of the mount assembly without frictional engagement of the mount members with respect to the mount wells.

8. The drive mount system of claim 1, wherein the mount surfaces of the mount members are spaced above the mounting surfaces of the formed mount wells at a desired spacing which is less than 0.1 inch.

9. The drive mount system of claim 1, wherein, when the driving device is mounted to the respective mount members, the respective mount members axially tilt the mount member relative to the formed mounting surfaces of the formed mount wells at an acute angle that is less than 2 degrees.

10. The drive mount system of claim 9, wherein the acute angle is less than 1 degree.

11. The drive mount system of claim 1, wherein the mount assembly further includes a bridge member having a central portion and integrally connected opposing end portions; wherein each respective end portion of the bridge member are coupled to a portion of the outer surface of the respective shoulder members of the pair of mount members.

12. The drive mount system of claim 11, further comprising a first pulley coupled to the distal portion of the drive shaft of the driving device and a second pulley coupled to the distal portion of the driven shaft of the driven device with the belt drive being positioned in contact with the respective first and second pulleys to effect transfer of rotational energy from the first pulley to the second pulley.

13. The drive mount system of claim 11, wherein the means for selectively moving the pair of spaced mount members axially along the mount wells and relative to the machine direction of the back plate comprises:
an elongated threaded rod mounted to an upper portion of the central portion of the bridge member; and
a ledge extending outwardly from a common plane of a peripheral side wall of the back plate and defining an elongated bore that is sized and shaped for complementary receipt of the elongated threaded rod, wherein the ledge is positioned along the machine axis of the back plate and co-axial to the longitudinal axis of the drive slot of the back member.

14. The drive mount system of claim 13, wherein the bore has an axis that is co-axial with the machine axis of the back plate.

15. The drive mount system of claim 14, wherein the elongated threaded rod operatively extends along an axis that is co-axial with the machine axis of the back plate when the elongated threaded rod is operatively received therein the bore of the ledge and when the mount members of the mount assembly are positioned therein the formed mount wells.

16. The drive mount system of claim 13, further comprising a drive nut configured to be rotatively received thereon the elongated threaded rod, wherein the drive nut is configured to be positioned in contact with an upper surface of the ledge and is configured to be rotatably driven about the elongated threaded rod to effect axial movement of the elongated threaded rod relative to the upper surface of the ledge.

17. The drive mount system of claim 16, wherein axial movement of the elongated threaded rod generates a complementary axial movement of the coupled mount assembly along the machine axis of the back plate resulting in complementary movement of the mount members along the mount wells and the complementary movement of the driving shaft along the machine direction and relative to the driven shaft.

18. The drive mount system of claim 16, further comprising a lock nut that is configured to be selectively positioned onto the elongated threaded rod and into contact with an upper surface of the drive nut to ensure that the mount assembly will not undesirably move from a position relative to the mount wells of the back plate when the desired level of tension in the rotating belt is achieved.

19. The drive mount system of claim 16, further comprising a threadlock adhesive that can be applied to the juncture of the respective threads of the drive nut and elongated threaded rod to ensure that the mount assembly will not undesirably move from a position relative to the mount wells of the back plate when the desired level of tension in the rotating belt is achieved.

20. The drive mount system of claim 1, wherein the exterior surface of the second lobe of the back member defines a plurality of mounts and a plurality of mount ribs that are configured to extend between respective spaced mounts such that the respective ends of respective mount ribs can be integrally formed with the adjoining mounts to form the ring structure.

21. The drive mount system of claim 20, wherein the opposed mounting surfaces of each mount well are positioned in a common plane that is parallel to the plane of the exterior surface of the back plate.

22. The drive mount system of claim 20, wherein the mount ribs extend to the substantial height of the adjoining mounts.

23. The drive mount system of claim 20, wherein the mount ribs extend to a height that is less than the height of the adjoining mounts.

24. The drive mount system of claim 20, wherein at least a portion of the mount ribs can have a curved profile.

25. The drive mount system of claim 20, wherein the plurality of mounts includes a bar mount that is positioned toward the peripheral edge of the second lobe of the back member and that is configured to be operatively coupled to a torque bar.

26. The drive mount system of claim 13, wherein the peripheral side wall terminates in a planar surface that is positioned in a common plane that is spaced from the planar back member at a desired distance.

27. The drive mount system of claim 3, further comprising a guard member defining a central opening, an upper slot, and a lower slot; wherein the guard member has a mount surface surrounding the central opening that is sized and shaped to allow for positioning relative to a complementary face surface of the driving device.

28. The drive mount system of claim 27, wherein the guard member is configured to be interposed between the face surface of the driving device and portions of the respective mount surfaces of the mount assembly such that the formed mount wells in the back plate are operatively enclosed irrespective of where the mount assembly is selectively positioned along the mount wells with respect to the machine direction of the back plate.

29. A drive mount system for operatively tensioning and enclosing a rotating belt drive operatively extending between a driving device and a driven device, comprising:
a mount housing having a back plate and a front cover that is selectably connected to the back plate to define an enclosed interior cavity when the front cover is selectively placed in a closed position relative to the back plate, wherein the back plate has a substantially planar back member that has a first lobe area and a second lobe area, wherein the back member defines a plurality of elongated slots in the first lobe of the back member, wherein one of the plurality of elongated slots is a drive slot that extends along a machine direction of the back plate and that is configured to receive a distal portion of a drive shaft of the driving device, wherein the plurality of elongated slots further includes a pair of opposed elongated mount slots that are positioned such that the drive slot is positioned between the mount slots forming the respective pair of mount slots, wherein each elongated mount slot forms a mount well having a longitudinal axis that extends parallel to the machine direction of the back plate, wherein each mount well has opposed mounting surfaces, wherein the back member further defines at least one opening in the second lobe of the back member that is configured to receive a distal portion a driven shaft of the driven device, wherein the exterior surface in the second lobe of the back member defines a ring structure that surrounds the at least one opening in the second lobe and that extends outwardly from the exterior surface of the back member, wherein distal portions of the ring structure are configured for mounting of the driven device such that a proximal portion of the driven shaft is enclosed in an interior void created by a face of the driven device, an interior wall structure of the ring structure, and a portion of the exterior surface of the back member that is bounded by the interior wall of the ring structure;
a mount assembly having a pair of spaced mount members, the mount assembly having a bridge member having a central portion and integrally connected opposing end portions; wherein each respective end portion of the bridge member are coupled to a portion of the outer surface of the respective shoulder members of the pair of mount members, wherein each mount member has a distal end portion that is shaped for receipt therein the respective formed mount wells, wherein each distal end portion terminates at a substantially planar mount surface and has an elongate length that is less than the elongate length of the formed mount well, wherein the mount surfaces of the mount members are spaced above the mounting surfaces of the formed mount wells at a desired spacing when the mount members are positioned therein the mount well; wherein the respective mount surfaces of the pair of spaced mount members are configured for mounting the driving device thereto such that the distal portion of the drive shaft of the driving device extends through the drive slot of the back member and into the interior cavity of the mount housing;
an elongated threaded rod mounted to an upper portion of the central portion of the bridge member and extending along an axis that is co-axial with the machine axis of the back plate; and
a ledge extending outwardly from a common plane of the peripheral side wall of the back plate and defining an elongated bore that is sized and shaped for complementary receipt of the elongated threaded rod, wherein the ledge is positioned along the machine axis of the back plate and co-axial to the longitudinal axis of the drive slot of the back member; and
a drive nut configured to be rotatively received thereon the elongated threaded rod, wherein the drive nut is configured to be positioned in contact with an upper surface of the ledge and is configured to be rotatably driven about the elongated threaded rod to effect axial movement of the elongated threaded rod relative to the upper surface of the ledge resulting in complementary movement of the pair of spaced mount members axially along the mount wells and relative to the machine direction of the back plate to obtain a desired distance between the driving shaft and the driven shaft that effects a desired level of tension in the rotating belt.
